(19) United States
(12) Patent Application Publication
(10) Pub. No.: US 2026/0059411 A1
(43) Pub. Date: Feb. 26, 2026

(54) NETWORK SWITCH SYSTEMS AND METHODS

(71) Applicant: DISH Wireless L.L.C., Englewood, CO (US)

(72) Inventors: Sisong Bei, Dublin, CA (US); Dmitry Dimov, San Francisco, CA (US); Mikhail Arbuzov, Santa Clara, CA (US); Sandeep Kilkarni, Englewood, CO (US)

(21) Appl. No.: 18/812,903

(22) Filed: Aug. 22, 2024

(51) Int. Cl. H04W 36/14; H04W 48/16

(52) U.S. Cl. CPC H04W 36/142; H04W 48/16

(57) ABSTRACT

A disclosed method may include (i) detecting, by a mobile virtual network operator, that an improvement in telecommunication service would result from performing a network switch that switches a home network of a client of the mobile virtual network operator from a first network infrastructure of a first mobile network operator that is serving clients for the mobile virtual network operator to a second network infrastructure of a second mobile network operator that is also serving clients for the mobile virtual network operator and (ii) detecting, by the mobile virtual network operator, that the network switch is prohibited at least in part by detecting that the client has failed to satisfy a condition that is controlled at least in part by the client and that is necessary for performing the network switch successfully.

### BRIEF SUMMARY

This disclosure is generally directed to systems, methods, and computer-readable media relating to performing a network switch. The technology described herein pertains to the field of mobile telecommunications, particularly in the context of entities broadly defined as mobile virtual network operators. A mobile virtual network operator can be an organization that provides wireless communication services to users without owning the underlying network infrastructure. Instead, mobile virtual network operators can lease wireless capacity from traditional mobile network operators, which own and maintain the actual telecommunications infrastructure. However, as used herein, the term mobile virtual network operator can be used broadly enough to also cover organizations, such as a parent organization, that function both as a mobile virtual network operator and a mobile network operator. In such cases, some clients might be served directly by the mobile virtual network operator's own infrastructure, while others might be served through network infrastructure owned by separate mobile network operators under agreement with the mobile virtual network operator. Mobile virtual network operators can encounter several distinct challenges due to their reliance on and interaction with varied network infrastructures. These challenges can involve resource allocation, cost management, service quality, and customer satisfaction. Addressing these challenges effectively can be helpful for mobile virtual network operators to deliver high-quality, reliable, and cost-effective services to their clients.

One of the primary challenges that mobile virtual network operators can face is managing the resources consumed while serving their clients. Resource consumption can directly impact operational costs, and inefficient resource management can lead to higher costs and reduced profitability. Mobile virtual network operators can benefit from carefully balancing their resource usage against cost constraints to maintain competitive pricing and profitability. The various embodiments of the technology described within this disclosure can address this issue by describing a system where a mobile virtual network operator can detect the proportion of time a user spends on different network infrastructures. By simulating network switches and calculating resource consumption post-switch, the mobile virtual network operator can make data-driven decisions to switch users to more cost-effective networks. This ability to dynamically adjust which network infrastructure serves a particular client can optimize resource use and control operational costs, especially in scenarios where the mobile virtual network operator operates its own infrastructure and also leases capacity from other mobile network operators. In practical terms, this means that a mobile virtual network operator can leverage real-time analytics and predictive modeling to determine efficient ways to serve each client, thereby potentially improving resource efficiency and reducing costs.

Maintaining service quality and providing a positive user experience can be significant challenges for mobile virtual network operators. Clients can expect seamless and reliable service comparable to that provided by traditional mobile network operators. However, maintaining consistent service quality when users switch between network infrastructures of different mobile network operators can be demanding. Users might experience variable service quality due to differences in network capabilities, coverage, and performance between different mobile network operators. This variability can lead to user dissatisfaction, complaints, and potential churn. The various embodiments of the technology described herein can address this challenge by enabling a mobile virtual network operator to simulate network switches and predict service quality post-switch. By verifying that the switch can result in not only lower resource consumption but also maintaining or improving service quality, the mobile virtual network operator can aim to minimize negative effects on the user experience from network switches.

Ensuring that client devices are compatible with multiple network infrastructures can be another issue to consider. Device incompatibility with different network infrastructures can lead to service disruptions and user dissatisfaction. For instance, a mobile device that works well on one network might not be fully compatible with another network's technology or frequency bands. The various embodiments of the technology described herein can verify the compatibility of client devices with various network infrastructures before performing a network switch. By verifying compatibility ahead of time, the mobile virtual network operator can ensure seamless transitions for users between different network infrastructures, thereby maintaining consistent service quality. This preemptive compatibility check can involve validating device capabilities, checking for firmware updates, and ensuring that necessary network configurations are in place. One goal is to minimize any potential disruptions and provide a smooth, uninterrupted service experience for the client. Geolocation of users can present yet another challenge for mobile virtual network operators. The absence of accurate geolocation data can impede effective resource management, service optimization, and targeted marketing efforts. Accurate geolocation information can be helpful for making informed decisions about network switches, optimizing network resources, and enhancing service delivery. In the described technology, the mobile virtual network operator can receive call detail records that may lack geolocation information. To overcome this limitation, the mobile virtual network operator can use third-party databases to match cell identifiers with geolocation data, thereby accurately determining the geolocation of users. Accurate geolocation can aid in better decision-making regarding network switches and resource allocation, ensuring that clients are connected to the most appropriate network infrastructure based on their location. Additionally, accurate geolocation can enable the mobile virtual network operator to offer location-based services and promotions, enhancing the overall client experience.

Verifying that clients are suitable candidates for network switches can be helpful for ensuring optimal service delivery. Not all users may benefit from a network switch, and some might even experience degraded service quality due to factors such as device compatibility or geographical location. The various embodiments of the technology described herein can perform verification tests to ensure that clients are suitable candidates for network switches. These tests can include verifying geolocation to ensure the client is in an area with adequate coverage from the target network, checking device compatibility to confirm that the user's device supports the new network's technology and frequency bands, assessing client tenure to prioritize long-term clients, and analyzing data usage patterns to determine the potential cost savings for the client. By performing these suitability tests, the mobile virtual network operator can ensure that only appropriate clients undergo network switches, thereby preserving or enhancing service quality. This targeted approach can help avoid unnecessary network switches that might not yield significant benefits for certain clients.

Detecting deficiencies in telecommunication services post-switch can be helpful to maintain high service standards and client satisfaction. The described technology can include methods for responsive and proactive detection of service deficiencies. Responsive detection can involve analyzing customer support interactions to identify reported issues, while proactive detection can involve monitoring connectivity patterns, network performance metrics, and client feedback to preemptively identify and resolve potential issues. For instance, if a significant number of clients report connectivity issues after a network switch, the mobile virtual network operator can investigate and address the root cause to prevent recurring problems. This dual approach of responsive and proactive detection can enable the mobile virtual network operator to maintain a high level of service quality and quickly address any emerging issues. Prompting clients to meet necessary conditions for successful network switches can also be important for ensuring seamless transitions. For instance, if a user's device is not compatible with a new network infrastructure, the mobile virtual network operator can prompt the user to upgrade their device. This can help ensure that network switches are performed more seamlessly or without causing service disruptions. The mobile virtual network operator can provide clear instructions and support to help clients upgrade their devices, ensuring that they are equipped with compatible technology for the new network infrastructure. This proactive approach can minimize potential disruptions and enhance the overall service experience for the client.

Overall, the technology described in this application can offer a comprehensive solution to various challenges faced by mobile virtual network operators. By optimizing resource consumption, ensuring service quality, verifying device and user compatibility, accurately determining geolocation, performing suitability tests, detecting service deficiencies, and/or prompting necessary actions, the technology can enable mobile virtual network operators to provide high-quality, cost-effective, and reliable telecommunication services to their clients.

In a first embodiment, a method can include: (i) detecting, by a mobile virtual network operator consuming a first amount of resources to serve a client of the mobile virtual network operator according to a current configuration, a proportion of time that the client connects to a first network infrastructure operated by a first mobile network operator in at least one location that is covered by a second network infrastructure operated by a second mobile network operator; (ii) simulating, by the mobile virtual network operator, that the mobile virtual network operator performed a network switch to switch a home network of the client from the first network infrastructure operated by the first mobile network operator to the second network infrastructure operated by the second mobile network operator; (iii) calculating, by the mobile virtual network operator based on the simulating, a second amount of resources that would be consumed by the mobile virtual network operator to serve the client after performing the network switch at least in part by modifying a consumption rate for resource consumption on the second network infrastructure based on the proportion of time that the client connects to the first network infrastructure in the at least one location that is covered by the second network infrastructure; (iv) detecting, by the mobile virtual network operator, that the second amount of resources that was calculated based on the simulating is less than the first amount of resources based on the current configuration; and (v) performing, by the mobile virtual network operator in response to detecting that the second amount of resources that was calculated based on the simulating is less than the first amount of resources based on the current configuration, the network switch. In some examples, both the first mobile network operator and the second mobile network operator agreed to provide cell service to clients of the mobile virtual network operator through their respective network infrastructures prior to the network switch.

In the first embodiment, the mobile virtual network operator also functions as the first mobile network operator.

In the first embodiment, the mobile virtual network operator also functions as the second mobile network operator.

In the first embodiment, the first mobile network operator and the second mobile network operator can comprise third-party mobile network operators that are distinct from the mobile virtual network operator.

In the first embodiment, a method can further include: (i) receiving, by the mobile virtual network operator from the first mobile network operator, a call detail record for the client that fails to specify a geolocation of the client; and (ii) geolocating, by the mobile virtual network operator, the client at least in part by matching a cell identifier from the call detail record that identifies a cell of a cell tower of the first mobile network operator that connected to the client with a geolocation for the cell identifier that is specified in a third-party database of cell identifier geolocations despite the call detail record for the client failing to specify the geolocation of the client.

In the first embodiment, the third-party database is open source.

In the first embodiment, a method can further include verifying, prior to the network switch, that the client is not excluded as a candidate from the network switch, by performing a set of verification tests.

In the first embodiment, the set of verification tests can comprise: (i) verifying whether the client is geolocatable; (ii) verifying whether a client device of the client is compatible with the second mobile network operator; or (iii) verifying that a tenure of the client is longer than a threshold tenure.

In the first embodiment, the set of verification tests can comprise: (i) verifying that an amount of data usage of the client is greater than a threshold amount; (ii) verifying that an amount of savings is greater than a threshold savings; or (iii) verifying that the client is primarily located at an area of interest where the second mobile network operator has launched.

In the first embodiment, a method can further include displaying a graphical user interface that includes a two-dimensional graph with one axis indicating a scale along which the proportion of time is measured.

In the first embodiment, a non-transitory computer-readable medium has instructions stored thereon that, when executed by at least one physical computing processor, cause a computing device to perform operations comprising: (i) detecting, by a mobile virtual network operator, consuming a first amount of resources to serve a client of the mobile virtual network operator according to a current configuration, a proportion of time that the client connects to a first network infrastructure operated by a first mobile network operator in at least one location that is covered by a second network infrastructure operated by a second mobile network operator; (ii) simulating, by the mobile virtual network operator, that the mobile virtual network operator performed a network switch to switch a home network of the client from the first network infrastructure operated by the first mobile network operator to the second network infrastructure operated by the second mobile network operator; (iii) calculating, by the mobile virtual network operator based on the simulating, a second amount of resources that would be consumed by the mobile virtual network operator to serve the client after performing the network switch at least in part by modifying a consumption rate for resource consumption on the second network infrastructure based on the proportion of time that the client connects to the first network infrastructure in the at least one location that is covered by the second network infrastructure; (iv) detecting, by the mobile virtual network operator, that the second amount of resources that was calculated based on the simulating is less than the first amount of resources based on the current configuration; and (v) performing, by the mobile virtual network operator in response to detecting that the second amount of resources that was calculated based on the simulating is less than the first amount of resources based on the current configuration, the network switch. In some examples, both the first mobile network operator and the second mobile network operator agreed to provide cell service to clients of the mobile virtual network operator through their respective network infrastructures prior to the network switch.

In the first embodiment, a system can comprise: (i) at least one physical computing processor of a computing device; and (ii) a non-transitory computer-readable medium that has instructions stored thereon that, when executed by the at least one physical computing processor, cause the computing device to perform operations comprising: (i) detecting, by a mobile virtual network operator, consuming a first amount of resources to serve a client of the mobile virtual network operator according to a current configuration, a proportion of time that the client connects to a first network infrastructure operated by a first mobile network operator in at least one location that is covered by a second network infrastructure operated by a second mobile network operator; (ii) simulating, by the mobile virtual network operator, that the mobile virtual network operator performed a network switch to switch a home network of the client from the first network infrastructure operated by the first mobile network operator to the second network infrastructure operated by the second mobile network operator; (iii) calculating, by the mobile virtual network operator based on the simulating, a second amount of resources that would be consumed by the mobile virtual network operator to serve the client after performing the network switch at least in part by modifying a consumption rate for resource consumption on the second network infrastructure based on the proportion of time that the client connects to the first network infrastructure in the at least one location that is covered by the second network infrastructure; (iv) detecting, by the mobile virtual network operator, that the second amount of resources that was calculated based on the simulating is less than the first amount of resources based on the current configuration; and (v) performing, by the mobile virtual network operator in response to detecting that the second amount of resources that was calculated based on the simulating is less than the first amount of resources based on the current configuration, the network switch. In some examples, both the first mobile network operator and the second mobile network operator agreed to provide cell service to clients of the mobile virtual network operator through their respective network infrastructures prior to the network switch.

In a second embodiment, a method can include: (i) receiving, by a mobile virtual network operator from a distinct mobile network operator that the mobile virtual network operator has assigned to serve a client of the mobile virtual network operator, a call detail record for the client of the mobile virtual network operator that fails to specify a geolocation of the client of the mobile virtual network operator; and (ii) geolocating, by the mobile virtual network operator, the client of the mobile virtual network operator at least in part by matching a cell identifier from the call detail record that identifies a cell of a cell tower of the distinct mobile network operator that connected to the client of the mobile virtual network operator with a geolocation for the cell identifier that is specified in a third-party database of cell identifier geolocations despite the call detail record for the client failing to specify the geolocation of the client of the mobile virtual network operator.

In the second embodiment, the third-party database is open source.

In the second embodiment, the geolocating can comprise detecting, by the mobile virtual network operator consuming a first amount of resources to serve the client of the mobile virtual network operator according to a current configuration, a proportion of time that the client connects to a first network infrastructure operated by a first mobile network operator in at least one location that is covered by a second network infrastructure operated by a second mobile network operator.

In the second embodiment, a method can further include displaying a graphical user interface that includes a two-dimensional graph with one axis indicating a scale along which a proportion of time is measured.

In the second embodiment, a method can further comprise simulating, by the mobile virtual network operator, that the mobile virtual network operator performed a network switch to switch a home network of the client from a first network infrastructure operated by a first mobile network operator to a second network infrastructure operated by a second mobile network operator.

In the second embodiment, a method can further include: (i) calculating, by the mobile virtual network operator based on the simulating, a second amount of resources that would be consumed by the mobile virtual network operator to serve the client after performing the network switch at least in part by modifying a consumption rate for resource consumption on the second network infrastructure based on the proportion of time that the client connects to the first network infrastructure in the at least one location that is covered by the second network infrastructure; (ii) detecting, by the mobile virtual network operator, that the second amount of resources that was calculated based on the simulating is less than the first amount of resources based on the current configuration; and (iii) performing, by the mobile virtual network operator in response to detecting that the second amount of resources that was calculated based on the simulating is less than the first amount of resources based on the current configuration, the network switch.

In the second embodiment, both the first mobile network operator and the second mobile network operator can agree to provide cell service to clients of the mobile virtual network operator through the first network infrastructure and the second network infrastructure, respectively, prior to the network switch.

In the second embodiment, a method can further include verifying, prior to a network switch, that the client is not excluded as a candidate from the network switch, by performing a set of verification tests.

In the second embodiment, the set of verification tests can comprise: (i) verifying whether the client is geolocatable; (ii) verifying whether a client device of the client is compatible with a second mobile network operator that is the target of the network switch; or (iii) verifying that a tenure of the client is longer than a threshold tenure.

In the second embodiment, the set of verification tests can comprise: (i) verifying that an amount of data usage of the client is greater than a threshold amount; (ii) verifying that an amount of savings is greater than a threshold savings; or (iii) verifying that the client is primarily located at an area of interest where the second mobile network operator that is the target of the network switch has launched.

In a third embodiment, a method can include: (i) performing, by a mobile virtual network operator, a network switch that switches a home network of a client of the mobile virtual network operator from a first network infrastructure of a first mobile network operator that is serving clients for the mobile virtual network operator to a second network infrastructure of a second mobile network operator that is also serving clients for the mobile virtual network operator; (ii) detecting, by the mobile virtual network operator, a deficiency in telecommunication service provided by the second network infrastructure of the second mobile network operator for the mobile virtual network operator to the client after performing the network switch; and (iii) performing, by the mobile virtual network operator, a remedial action to resolve the deficiency that the mobile virtual network operator detected in telecommunication service provided by the second network infrastructure of the second mobile network operator for the mobile virtual network operator to the client after performing the network switch.

In the third embodiment, detecting the deficiency in telecommunication service can be performed by the mobile virtual network operator in response to the client first notifying the mobile virtual network operator regarding the deficiency in telecommunication service.

In the third embodiment, detecting the deficiency in telecommunication service can be performed by the mobile virtual network operator analyzing a set of customer support center call transcriptions.

In the third embodiment, detecting the deficiency in telecommunication service can be performed by the mobile virtual network operator: (i) prompting a large language model to summarize the set of customer support center call transcriptions such that a set of customer support center call transcription summaries is generated; and (ii) vectorizing the set of customer support center call transcription summaries through word embeddings to generate a set of vectorized customer support center call transcription summaries.

In the third embodiment, detecting the deficiency in telecommunication service can be performed by the mobile virtual network operator: (i) clustering the set of vectorized customer support center call transcription summaries to generate a set of vectorized customer support center call transcription summary clusters; and (ii) rank ordering the set of vectorized customer support center call transcription summary clusters in order of priority to the mobile virtual network operator.

In the third embodiment, detecting the deficiency in telecommunication service can be performed by the mobile virtual network operator proactively without the client first notifying the mobile virtual network operator regarding the deficiency in telecommunication service.

In the third embodiment, detecting the deficiency in telecommunication service can be performed by the mobile virtual network operator detecting a deficiency in cellular connectivity.

In the third embodiment, the remedial action can remediate the deficiency in cellular connectivity by restoring a higher level of cellular connectivity.

In the third embodiment, detecting the deficiency in telecommunication service can be performed by the mobile virtual network operator detecting a pattern of clients leaving the mobile virtual network operator.

In the third embodiment, performing the remedial action to resolve the deficiency that the mobile virtual network operator detected in telecommunication service can comprise reversing the network switch back to the first network infrastructure of the first mobile network operator that is serving clients for the mobile virtual network operator.

In a fourth embodiment, a method can include: (i) detecting, by a mobile virtual network operator, that an improvement in telecommunication service would result from performing a network switch that switches a home network of a client of the mobile virtual network operator from a first network infrastructure of a first mobile network operator that is serving clients for the mobile virtual network operator to a second network infrastructure of a second mobile network operator that is also serving clients for the mobile virtual network operator; (ii) detecting, by the mobile virtual network operator, that the network switch is prohibited at least in part by detecting that the client has failed to satisfy a condition that is controlled at least in part by the client and that is necessary for performing the network switch successfully; and (iii) prompting, by the mobile virtual network operator, in response to the mobile virtual network operator detecting that the network switch is prohibited at least in part by detecting that the client has failed to satisfy the condition that is controlled at least in part by the client and that is necessary for performing the network switch successfully, the client to satisfy the necessary condition to perform the network switch that switches the client of the mobile virtual network operator from the first network infrastructure of the first mobile network operator that is serving clients for the mobile virtual network operator to the second network infrastructure of the second mobile network operator that is also serving clients for the mobile virtual network operator.

In the fourth embodiment, the condition can comprise the client using a mobile device model that is not supported by the second network infrastructure of the second mobile network operator that is also serving clients for the mobile virtual network operator.

In the fourth embodiment, prompting the client to satisfy the necessary condition to perform the network switch can comprise the mobile virtual network operator prompting the client to upgrade to another mobile device model that is supported by the second network infrastructure of the second mobile network operator that is also serving clients for the mobile virtual network operator.

In the fourth embodiment, a method can further include performing, by the mobile virtual network operator, the network switch.

In the fourth embodiment, a method can further comprise receiving, by the mobile virtual network operator, an indication that the client has satisfied the condition that is controlled at least in part by the client and that is necessary for performing the network switch successfully.

In the fourth embodiment, the mobile virtual network operator can perform the network switch in response to receiving the indication that the client has satisfied the condition that is controlled at least in part by the client and that is necessary for performing the network switch successfully.

In the fourth embodiment, the network switch can be performed invisibly by switching an active profile on a subscriber identity module for the client from a first profile that is specific to the first network infrastructure of the first mobile network operator to a second profile that is specific to the second network infrastructure of the second mobile network operator.

In the fourth embodiment, performing the network switch can comprise switching an active profile on a subscriber identity module card of the client from a first profile corresponding to the first network infrastructure to a second profile corresponding to the second network infrastructure.

In the fourth embodiment, prompting the client to satisfy the necessary condition can comprise providing an upgrade recommendation for a compatible mobile device model that operates with the second network infrastructure.

In the fourth embodiment, the prompting can comprise sending a notification to the client with instructions on how to meet the necessary condition for the network switch.

### BRIEF DESCRIPTION OF THE DRAWINGS

For a better understanding of the present invention, reference will be made to the following Detailed Description, which is to be read in association with the accompanying drawings:

FIG. 1A illustrates an example method that a mobile virtual network operator can use to decide whether to perform a network switch for a client based on resource consumption calculations.

FIG. 1B depicts an example method for geolocating a client of a mobile virtual network operator using a third-party database of cell identifier geolocations when a call detail record lacks geolocation information.

FIG. 1C shows an example method for detecting and resolving deficiencies in telecommunication service after performing a network switch for a client of a mobile virtual network operator.

FIG. 1D illustrates an example method for prompting a client to satisfy necessary conditions for a network switch when an improvement in telecommunication service would result from the switch.

FIG. 2 depicts an example scenario showing potential cost savings for a mobile virtual network operator when migrating a subscriber from one mobile network operator area of interest to another.

FIG. 3 shows an example process of combining mobile virtual network operator tower data with 5G tower data from mobile network operators.

FIG. 4 illustrates an example user interface displaying various filters and a count of compatible subscribers for a potential network switch.

FIG. 5 depicts an example user interface showing average annual savings and total annual savings for a mobile virtual network operator broken down by usage bin and coverage bin.

FIG. 6 illustrates the user interface of FIG. 5 with a pop-up notification highlighted.

FIG. 7 depicts the user interface of FIG. 5 with particular bins selected.

FIG. 8 illustrates the user interface of FIG. 5 with an area of interest component highlighted.

FIG. 9 illustrates the user interface of FIG. 5 with a manufacturer component highlighted.

FIG. 10 depicts the user interface of FIG. 5 updated after changing a mobile network operator roaming rate.

FIGS. 11A-11B illustrate a sequence of steps for changing a subscriber's active subscriber identity module profile.

FIG. 12 depicts a high-level overview of some steps that can be involved when a mobile virtual network operator enables a new subscriber identity module profile and ports a number for a subscriber.

FIG. 13 shows a flow diagram for a method for strategizing tower placement.

FIG. 14 illustrates an example visualization of mobile virtual network operator cell sites and their distance from a native MNO cell site for a geographic region.

FIG. 15 depicts a zoomed in view of the visualization in FIG. 14 for a particular area of interest.

FIG. 16 illustrates an alternative zoomed in view of the visualization in FIG. 14.

FIG. 17 illustrates a method for calculating potential cost savings when switching a subscriber between mobile network operators.

FIG. 18 shows example data associating cell site identifiers with geographic location, area of interest, city, state and zip code.

FIG. 19 illustrates example data showing a subscriber's usage broken down by area of interest.

FIG. 20 depicts an example spreadsheet showing how cost savings are calculated for the mobile virtual network operator after migrating subscribers.

FIG. 21 illustrates a client experiencing connectivity issues due to an incompatible smartphone within a residential setting.

FIG. 22 depicts the client receiving and considering information from the mobile virtual network operator about upgrading their device for improved service.

FIG. 23 shows a three-panel sequence of the client ordering a new compatible device, the delivery process, and the client receiving the package.

FIG. 24 demonstrates the successful outcome of the network switch, with the client using their new compatible device and experiencing improved connectivity in the same residential setting as FIG. 21.

FIG. 25 illustrates an example computing system that can be used to implement the functionality described herein.

### DETAILED DESCRIPTION

The following description, along with the accompanying drawings, sets forth certain specific details in order to provide a thorough understanding of various disclosed embodiments.

However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

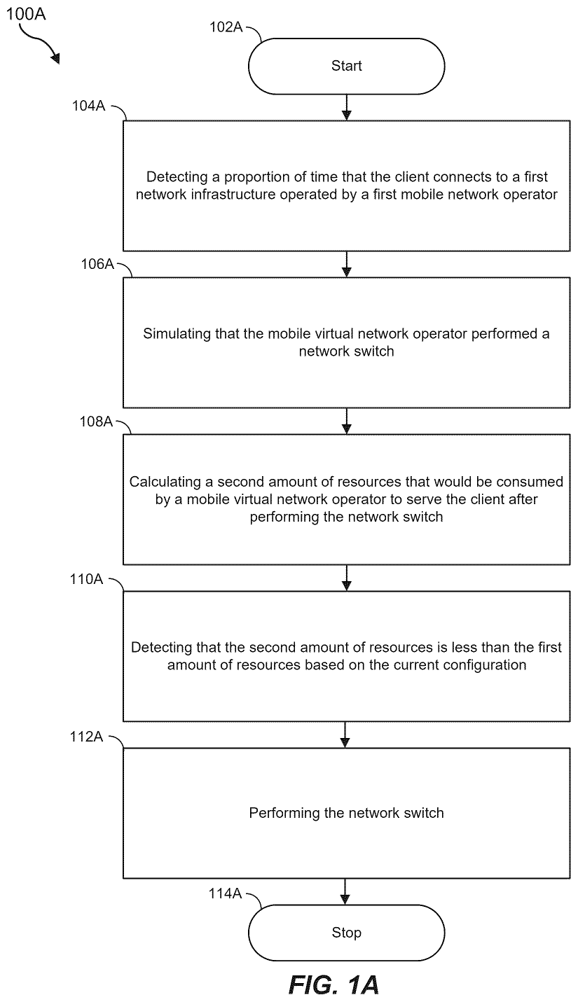

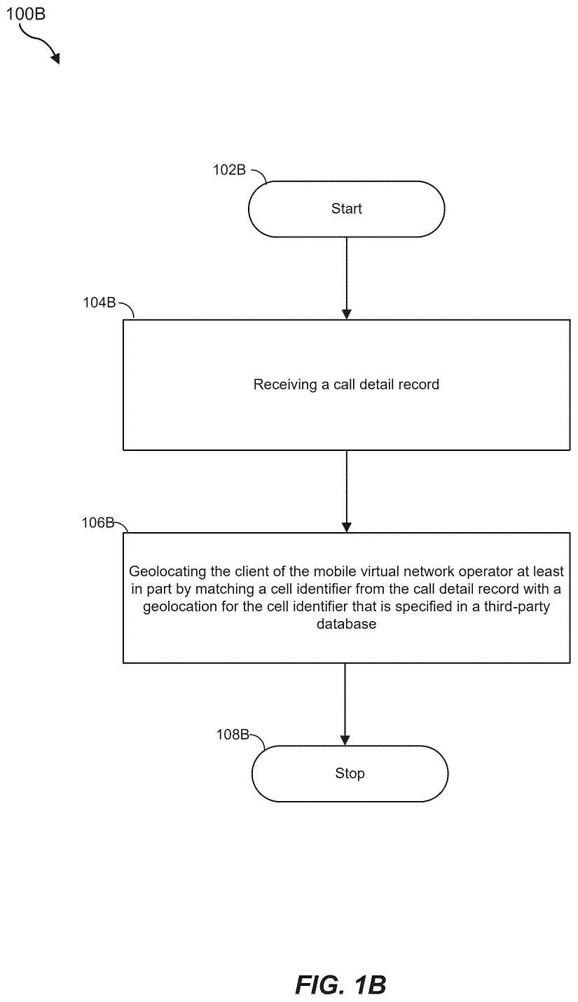

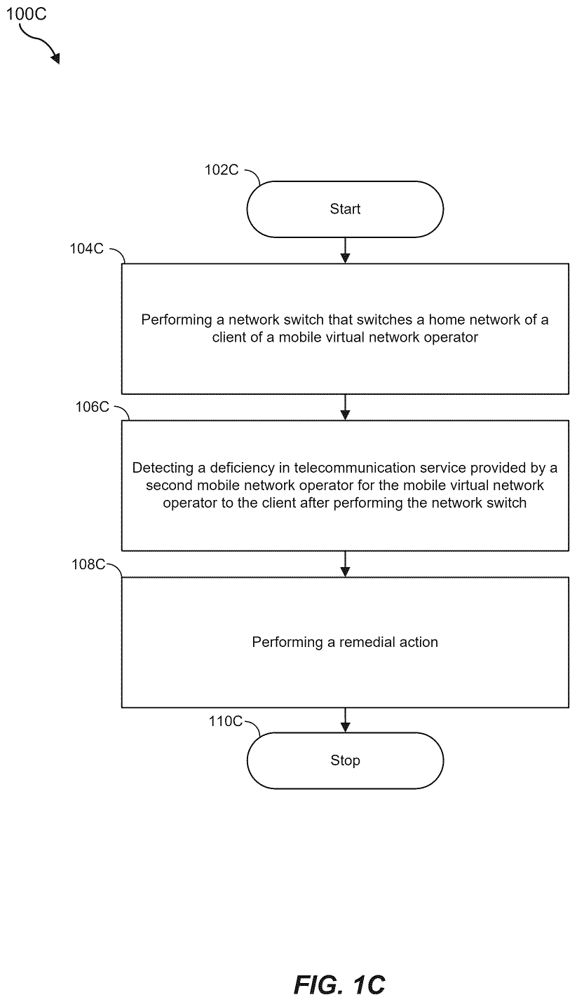

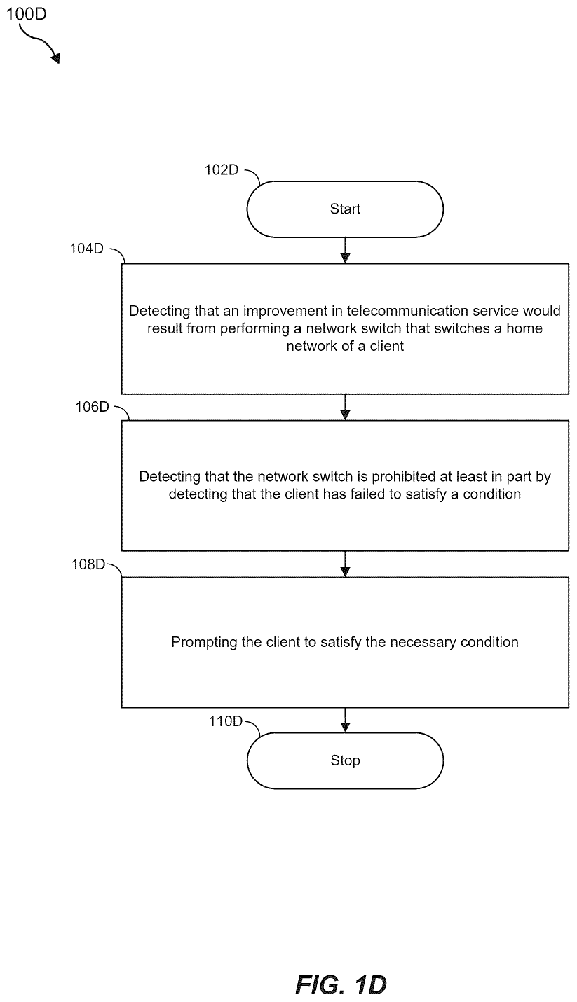

FIG. 1A depicts a method 100A relating to a network switch for a mobile virtual network operator, specifically focusing on resource consumption calculations. At step 102A, method 100A can start or begin. At step 104A, method 100A can include detecting that a mobile virtual network operator, consuming a first amount of resources to serve a client of the mobile virtual network operator according to a current configuration, detects a proportion of time that the client connects to a first network infrastructure operated by a first mobile network operator in at least one location that is covered by a second network infrastructure operated by a second mobile network operator. At step 106A, method 100A can include simulating that the mobile virtual network operator performed a network switch to switch a home network of the client from the first network infrastructure operated by the first mobile network operator to the second network infrastructure operated by the second mobile network operator. At step 108A, method 100A can include calculating, based on the simulating, a second amount of resources that would be consumed by the mobile virtual network operator to serve the client after performing the network switch at least in part by modifying a consumption rate for resource consumption on the second network infrastructure based on the proportion of time that the client connects to the first network infrastructure in the at least one location that is covered by the second network infrastructure. At step 110A, method 100A can include detecting that the second amount of resources calculated based on the simulating is less than the first amount of resources based on the current configuration. At step 112A, method 100A can include performing, in response to detecting that the second amount of resources calculated based on the simulating is less than the first amount of resources based on the current configuration, the network switch. In some examples, both the first mobile network operator and the second mobile network operator agreed to provide cell service to clients of the mobile virtual network operator through the first network infrastructure and the second network infrastructure, respectively, prior to the network switch. Finally, method 100A can terminate at step 114A.

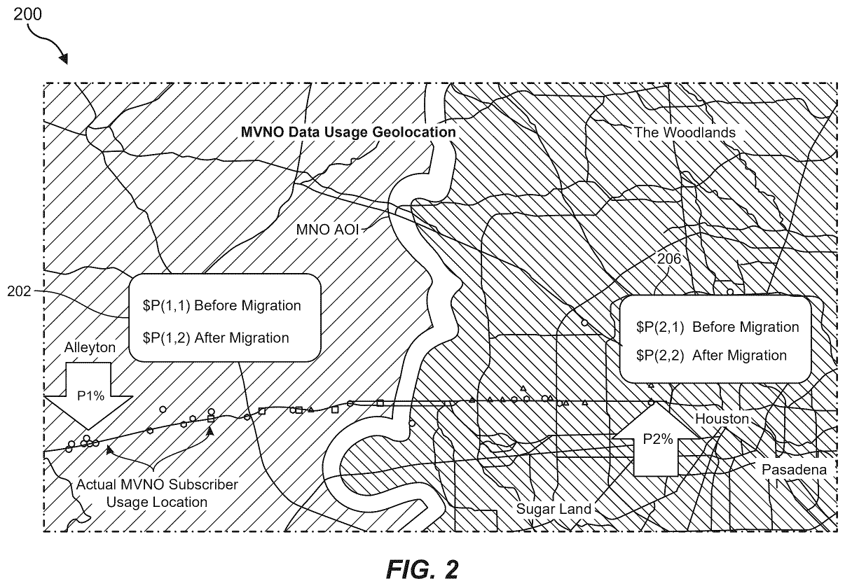

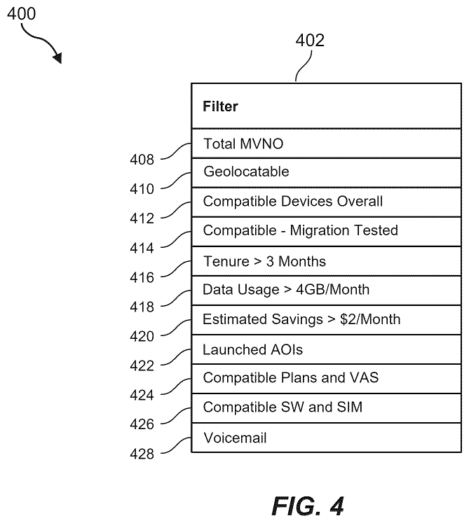

This method of network switching based on resource consumption calculations can contribute to the optimization strategy of the mobile virtual network operator. It is illustrated in detail in FIG. 1A and relates closely to the data visualization techniques shown in FIGS. 2-10. The approach focuses on the proportion of time a client spends on different networks, which can allow for more accurate resource consumption predictions. This method can form a basis for other optimization techniques described in this application, as it can provide a framework for evaluating the potential benefits of network switches. The process involves detecting usage patterns, simulating network switches, and calculating potential resource savings, as depicted in the flowchart of FIG. 1A. These calculations can be visualized using the graphical interfaces shown in FIGS. 4-10, which illustrate how different factors such as usage bins, coverage bins, and potential savings can be analyzed. This approach can enable the mobile virtual network operator to make data-driven decisions about network switching, potentially leading to more efficient resource allocation and improved service for clients. By considering factors such as the time spent on different networks and simulated resource consumption, this method can provide a comprehensive basis for network optimization decisions.

As discussed further below, in some implementations, the mobile virtual network operator can also function as the first mobile network operator or the second mobile network operator. Alternatively, the first mobile network operator and the second mobile network operator can comprise third-party mobile network operators that are distinct from the mobile virtual network operator.

FIG. 1B depicts a method 100B relating to a network switch for a mobile virtual network operator, specifically addressing geolocation challenges when call detail records lack location information. At step 102B, method 100B can start or begin. At step 104B, method 100B can include receiving, by a mobile virtual network operator from a distinct mobile network operator that the mobile virtual network operator has assigned to serve a client of the mobile virtual network operator, a call detail record for the client of the mobile virtual network operator that fails to specify a geolocation of the client of the mobile virtual network operator. At step 106B, method 100B can include geolocating, by the mobile virtual network operator, the client of the mobile virtual network operator at least in part by matching a cell identifier from the call detail record that identifies a cell of a cell tower of the distinct mobile network operator that connected to the client of the mobile virtual network operator with a geolocation for the cell identifier that is specified in a third-party database of cell identifier geolocations despite the call detail record for the client failing to specify the geolocation of the client of the mobile virtual network operator. Finally, method 100B can terminate at step 108B.

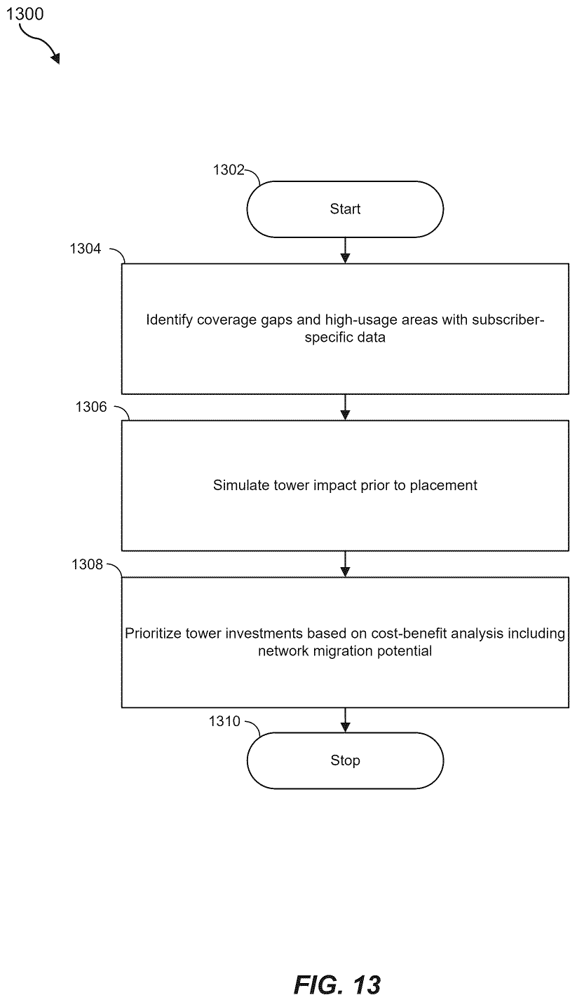

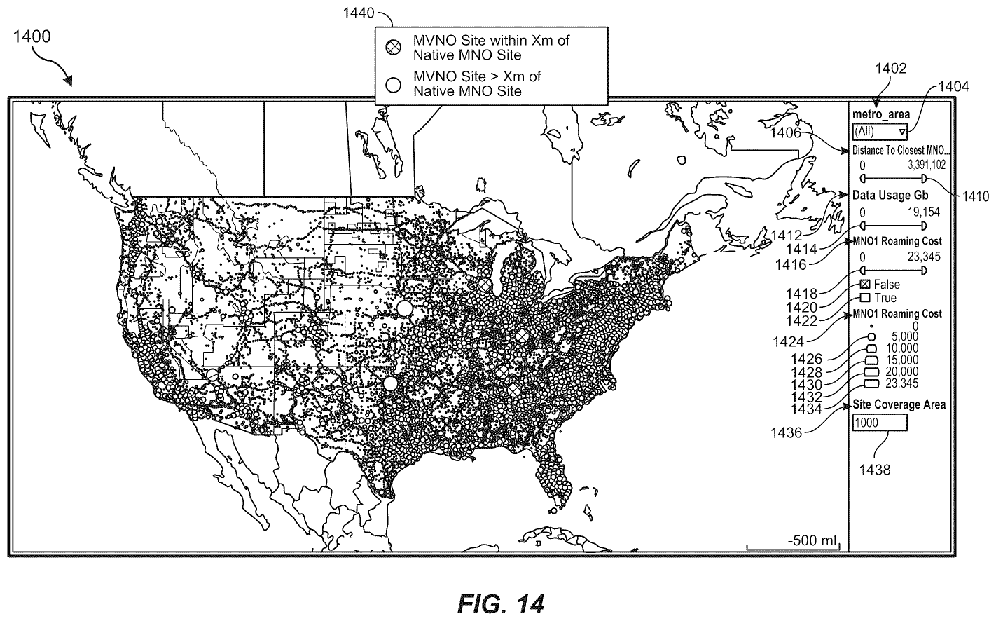

The geolocation method described here can address a challenge in network optimization: accurately determining client locations when call detail records lack this information. This process, outlined in FIG. 1B, can enable the resource consumption calculations detailed in the previous method. The contribution of this method can include the use of third-party databases to match cell identifiers with geolocation data, potentially allowing for more comprehensive network analysis. This method can be particularly relevant to the visualizations in FIGS. 13-17, which illustrate how geolocation data can be used to analyze network coverage and plan infrastructure improvements. The geolocation process can involve receiving call detail records, identifying cell identifiers, and matching these with location data from third-party sources. This information can then be used to create detailed maps of client activity and network coverage, as shown in FIGS. 14-16. These visualizations can help the mobile virtual network operator identify areas where network coverage can be improved or where network switches might be beneficial. By integrating this geolocation data with other network metrics, the mobile virtual network operator can potentially make more informed decisions about network optimization and infrastructure investments. The ability to accurately locate clients even with limited information can significantly enhance the overall network switching and optimization process.

FIG. 1C illustrates a method 100C relating to a network switch for a mobile virtual network operator, specifically dealing with post-switch service deficiencies and remediation. At step 102C, method 100C can start or begin. At step 104C, method 100C can include performing, by a mobile virtual network operator, a network switch that switches a home network of a client of the mobile virtual network operator from a first network infrastructure of a first mobile network operator that is serving clients for the mobile virtual network operator to a second network infrastructure of a second mobile network operator that is also serving clients for the mobile virtual network operator. At step 106C, method 100C can include detecting, by the mobile virtual network operator, a deficiency in telecommunication service provided by the second network infrastructure of the second mobile network operator for the mobile virtual network operator to the client after performing the network switch. At step 108C, method 100C can include performing, by the mobile virtual network operator, a remedial action to resolve the deficiency that the mobile virtual network operator detected in telecommunication service provided by the second network infrastructure of the second mobile network operator for the mobile virtual network operator to the client after performing the network switch. Finally, method 100C can terminate at step 110C.

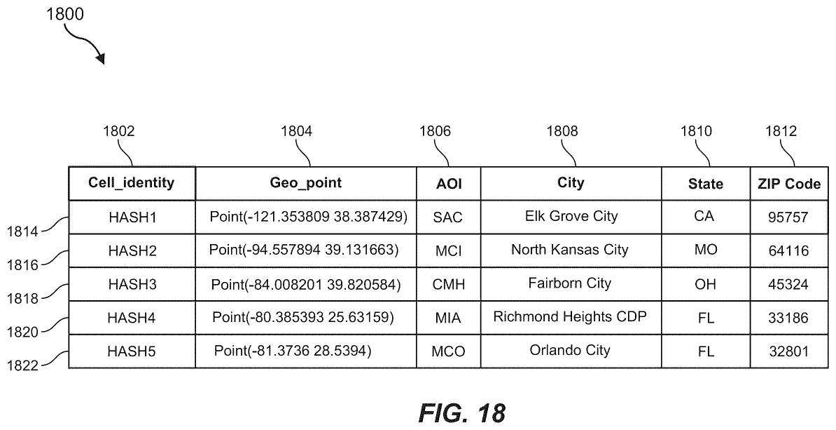

This approach to detecting and resolving service deficiencies after a network switch, as outlined in FIG. 1C, can represent a feedback loop in the network optimization process of the mobile virtual network operator. It focuses on the post-switch phase, aiming to ensure that the theoretical benefits of network switching translate into actual improvements in service quality. This method can relate to the customer experience evaluation techniques discussed throughout the application, particularly in the context of the data analysis methods shown in FIGS. 18-20. The process can involve monitoring service quality after a network switch, detecting any deficiencies, and taking remedial action to address these issues. This can include analyzing customer support interactions to identify potential service problems. The data analysis techniques illustrated in FIGS. 18-20 can be applied to this process, helping to identify patterns in service deficiencies and calculate the impact of these issues on overall network performance and cost savings. By implementing this feedback loop, the mobile virtual network operator can potentially refine network switching strategies over time, leading to improved service quality and customer satisfaction. This approach emphasizes the importance of continuous monitoring and improvement in the network switching process, ensuring that theoretical benefits are realized in practice.

Method 100C can encompass various embodiments that address the diverse nature of potential service deficiencies and the corresponding remedial actions. One aspect of method 100C can be the detection of telecommunication service deficiencies, which can be triggered in two primary ways. The first way is reactively, in response to a client reporting an issue. Reactive detection can typically involve the client contacting the mobile virtual network operator's customer support center to report a problem they are experiencing. The mobile virtual network operator can then analyze these reports, potentially identifying patterns and trends that may indicate a systemic deficiency in service quality. This analysis might involve examining customer support call transcriptions, emails, or other forms of communication to pinpoint the specific nature of the reported issues. For example, if multiple clients report dropped calls in a particular location after being switched to a new network, this could suggest a coverage gap or signal interference issue in that area. The mobile virtual network operator could then investigate this further, potentially by examining network performance data or dispatching technicians to assess the signal strength and quality in the affected location.

The second way that a deficiency can be detected is proactively, through the mobile virtual network operator's own monitoring and analysis. Proactive detection can rely on the mobile virtual network operator's ability to continuously monitor network performance and attempt to identify potential service deficiencies before they are reported by clients. This can involve analyzing various network metrics, such as call drop rates, data connection speeds, and signal strength, to detect anomalies or deviations from expected performance levels. For instance, a sudden increase in call drop rates within a specific geographic area after a network switch could indicate a coverage issue with the new network infrastructure. In such a case, the mobile virtual network operator could proactively investigate the issue and take steps to improve coverage, such as adjusting cell tower settings, adding new cell towers, or rerouting traffic to less congested network segments. This proactive approach can help minimize service disruptions and improve client satisfaction, as issues can be addressed before they significantly impact a large number of clients.

The types of telecommunication service deficiencies that method 100C can address are diverse, encompassing a wide range of potential issues that can impact a client's experience with the network. Some examples include cellular connectivity issues, messaging problems, voicemail malfunctions, and billing discrepancies. Cellular connectivity issues can manifest in various ways, such as dropped calls, poor call quality, slow data speeds, or the inability to connect to the network at all. These issues can be caused by a variety of factors, including insufficient network coverage, signal interference, equipment malfunctions, or device incompatibility. Messaging problems can involve delays in sending or receiving text messages, difficulties with multimedia messaging services (MMS), or issues with group messaging. Voicemail malfunctions can include problems with accessing or retrieving voicemail messages, setting up voicemail greetings, or managing voicemail settings. Billing discrepancies can involve clients being incorrectly billed for services, experiencing issues with payment processing, or having difficulties understanding their billing statements.

Once a service deficiency is detected, method 100C outlines various remedial actions that the mobile virtual network operator can undertake to resolve the issue. The specific remedial action taken will depend on the nature of the deficiency and its root cause. One category of remedial actions involves network optimization. If the deficiency is related to network coverage or performance, the mobile virtual network operator can attempt to optimize the network infrastructure by adjusting cell tower settings, adding new cell towers, or rerouting traffic to less congested network segments. For instance, if a particular cell tower is experiencing high traffic volume, the mobile virtual network operator can adjust the tower's power output or antenna tilt to improve coverage in specific areas. In cases of severe congestion, the mobile virtual network operator might consider deploying a new cell tower to increase capacity and improve service quality for clients in the affected area. Network optimization techniques can be complex and may require specialized expertise and tools, but they are helpful for ensuring that the network can meet the demands of its users and provide a satisfactory service experience.

Another category of remedial actions involves device troubleshooting. If the service deficiency stems from client device incompatibility or malfunction, the mobile virtual network operator can provide troubleshooting support to the client. This may involve guiding the client through device settings adjustments, software updates, or recommending a device replacement if necessary. For instance, if a client is experiencing slow data speeds, the mobile virtual network operator can check if the client's device is compatible with the network's data technology and if the device's software is up to date. If the issue persists, the mobile virtual network operator might recommend that the client upgrade to a newer device that supports the latest network technologies. In some cases, the mobile virtual network operator might offer a subsidized device upgrade program to clients who are experiencing service deficiencies due to outdated or incompatible devices.

The mobile virtual network operator can also undertake service reconfiguration as a remedial action. If the deficiency is related to a specific service, such as voicemail or messaging, the mobile virtual network operator can attempt to reconfigure the service settings or provisioning. This can involve resetting the service, updating software components, or coordinating with the underlying mobile network operator to resolve any technical issues. For example, if a client is unable to access their voicemail, the mobile virtual network operator can reset the client's voicemail account, check for any service outages, or contact the underlying mobile network operator to investigate potential problems with their voicemail platform. In some cases, the mobile virtual network operator might need to update their own service provisioning systems to ensure compatibility with the underlying mobile network operator's infrastructure.

Billing adjustments represent another category of remedial actions that the mobile virtual network operator can implement. If the deficiency involves billing errors, the mobile virtual network operator can issue credits or refunds to the client to correct the problem. This can involve reviewing the client's billing history, identifying any incorrect charges, and applying appropriate adjustments to their account. The mobile virtual network operator can also work with the client to clarify any billing questions or concerns, ensuring that they understand the charges on their statement and the billing process. In some cases, the mobile virtual network operator might implement system improvements to prevent similar billing errors from occurring in the future.

In certain situations, the most effective remedial action may be to reverse the network switch, returning the client to their original network infrastructure. This can be an option if, for example, the new network is consistently unable to provide satisfactory service quality or if the underlying cause of the deficiency proves difficult to resolve. While reversing the network switch may not be ideal, it can be a necessary step to ensure that the client receives adequate service and remains satisfied with the mobile virtual network operator. The mobile virtual network operator can monitor the performance of both their own network and their partner networks to make informed decisions about which network infrastructure is most suitable for each client.

Method 100C can also utilize advanced analytical techniques to enhance the detection and resolution of service deficiencies. For example, the mobile virtual network operator can employ machine learning algorithms to analyze customer support call transcripts and identify patterns that may indicate specific types of service issues. This analysis can involve prompting a large language model to summarize the call transcripts and then vectorizing those summaries using word embeddings. By clustering these vectorized summaries, the mobile virtual network operator can identify groups of calls that share common themes or topics, potentially revealing systemic service deficiencies. Further, the mobile virtual network operator can prioritize these clusters based on their frequency or severity, enabling them to focus their efforts on resolving the most widespread or impactful issues. This data-driven approach to service deficiency analysis can help the mobile virtual network operator identify and address problems more efficiently, improving the overall quality of their service and enhancing client satisfaction.

FIG. 1D shows a method 100D relating to a network switch for a mobile virtual network operator, specifically addressing scenarios where client-controlled conditions prevent an otherwise beneficial network switch. At step 102D, method 100D can start or begin. At step 104D, method 100D can include detecting, by a mobile virtual network operator, that an improvement in telecommunication service would result from performing a network switch that switches a home network of a client of the mobile virtual network operator from a first network infrastructure of a first mobile network operator that is serving clients for the mobile virtual network operator to a second network infrastructure of a second mobile network operator that is also serving clients for the mobile virtual network operator. At step 106D, method 100D can include detecting, by the mobile virtual network operator, that the network switch is prohibited at least in part by detecting that the client has failed to satisfy a condition that is controlled at least in part by the client and that is necessary for performing the network switch successfully. At step 108D, method 100D can include prompting, by the mobile virtual network operator, in response to the mobile virtual network operator detecting that the network switch is prohibited at least in part by detecting that the client has failed to satisfy the condition that is controlled at least in part by the client and that is necessary for performing the network switch successfully, the client to satisfy the necessary condition to perform the network switch that switches the client of the mobile virtual network operator from the first network infrastructure of the first mobile network operator that is serving clients for the mobile virtual network operator to the second network infrastructure of the second mobile network operator that is also serving clients for the mobile virtual network operator. Finally, method 100D can terminate at step 110D.

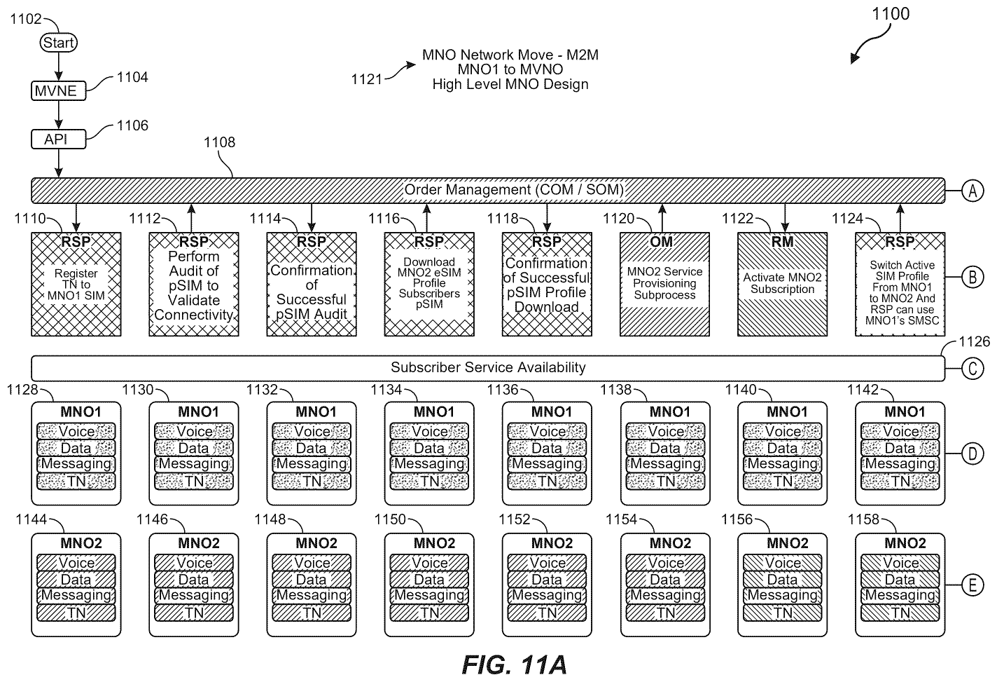

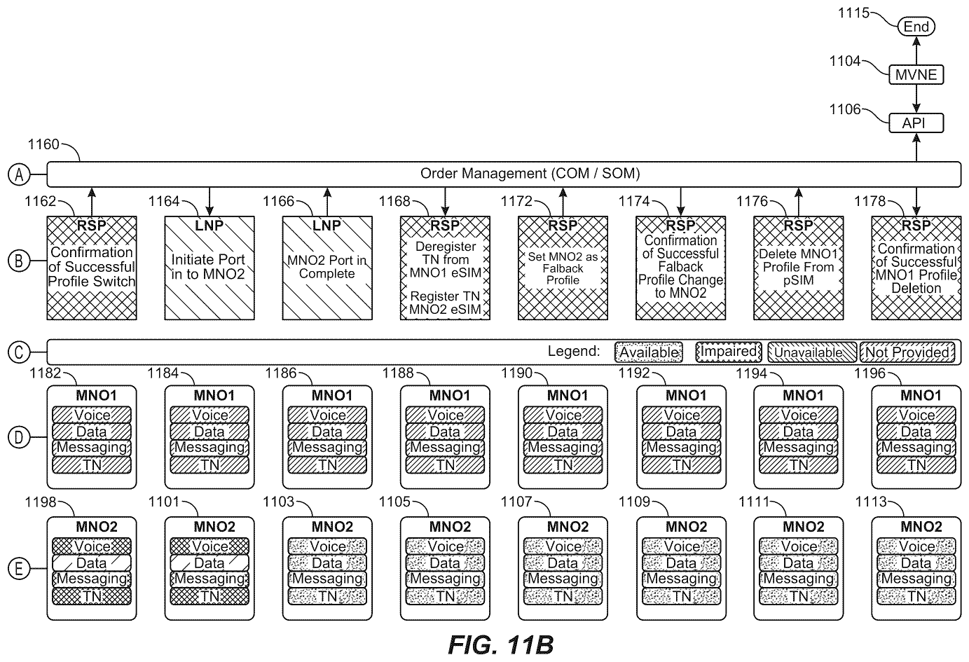

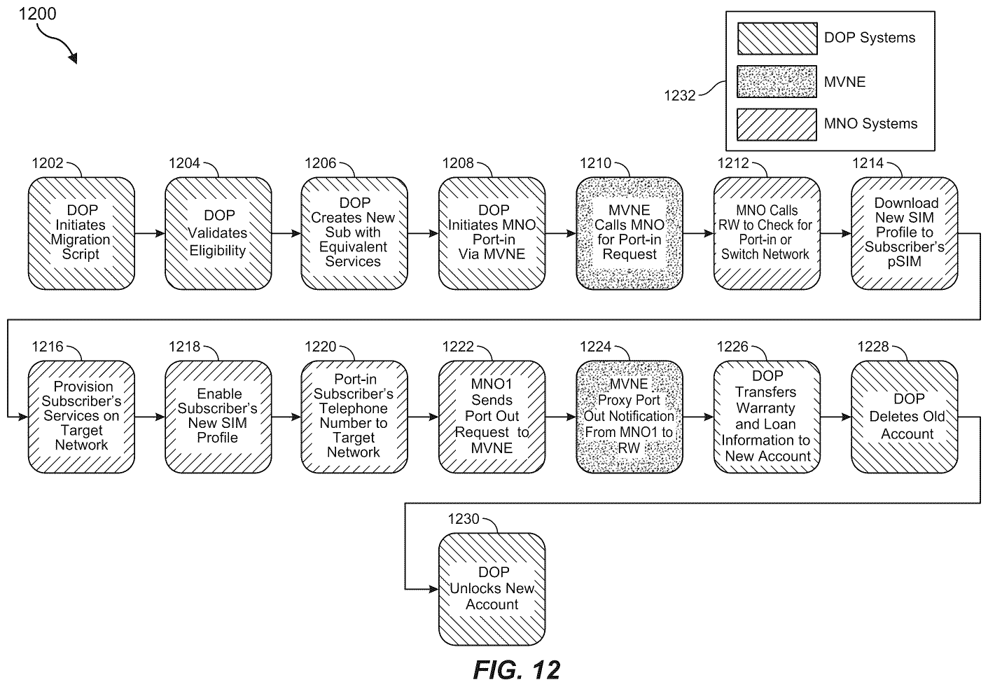

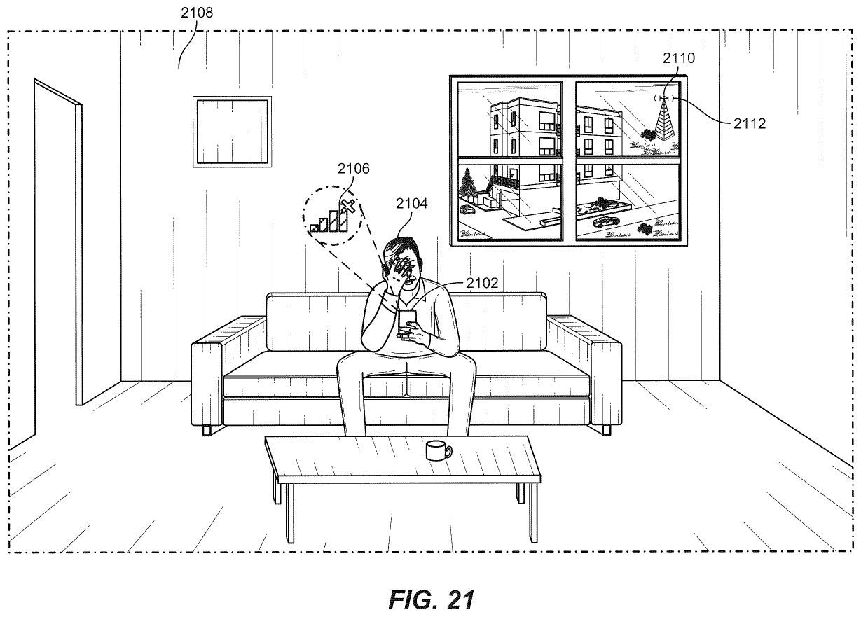

The method of prompting clients to meet necessary conditions for network switching, as depicted in FIG. 1D, can address a challenge in network optimization: client-side limitations. This approach can engage with clients to overcome obstacles to beneficial network switches, rather than simply identifying potential switches. It can tie closely to the device compatibility considerations discussed throughout the application and can be particularly relevant to the network switching process illustrated in FIGS. 11A-12. The process can involve detecting potential improvements from a network switch, identifying client-side obstacles to the switch, and prompting the client to take action to overcome these obstacles. This can include scenarios such as recommending device upgrades or prompting clients to update device settings, as discussed in connection with FIGS. 21-24. The network switching process detailed in FIGS. 11A-12 can illustrate how these client-side actions integrate into the overall network switching procedure. By proactively addressing client-side limitations, this method can potentially increase the number of successful network switches, leading to improved network efficiency and service quality. This approach can also enhance the ability of the mobile virtual network operator to optimize network resources by ensuring that clients can take full advantage of available network improvements. The focus on client engagement and proactive problem-solving distinguishes this method from passive network optimization techniques.

FIG. 2 depicts a diagram 200 illustrating the complexities of potential cost savings for a mobile virtual network operator when deciding whether to migrate a subscriber from one mobile network operator to another. This figure highlights the importance of considering both subscriber geolocation and usage patterns across multiple locations in the decision-making process for network switching. The figure showcases a map with several cities in Texas highlighted, representing different areas where the mobile virtual network operator analyzes subscriber usage and network coverage to assess the potential benefits of a network switch. The map shows actual mobile virtual network operator subscriber usage locations, indicated by dots spread across different cities. All of the dots on the map represent the same subscriber, allowing for a comprehensive view of their usage patterns across various locations. This visual representation of usage data enables the mobile virtual network operator to understand subscriber behavior and identify areas where network switching may be beneficial or detrimental.

By way of illustrative example, a cluster of dots is concentrated in one city, Alleyton, suggesting that the subscriber spends a significant portion of their time, such as 30%, in this location. Notification 202, including “$P(1,1) Before Migration” (such as $3) and “$P(1,2)After Migration,” (such as $4) is associated with this area, illustrating the potential change in costs after migrating the subscriber to a different mobile network operator. In this case of $3 and $4, respectively, the cost after migration is higher than the cost before migration. This scenario can occur because the target mobile network operator, while being the native infrastructure of the mobile virtual network operator, does not yet have the same level of coverage and economies of scale as the current mobile network operator serving the subscriber in this location. As a result, the mobile virtual network operator might incur higher roaming charges or face less favorable data rates in this area if the subscriber is migrated.

As another illustrative example, another cluster of dots is concentrated in the Houston metropolitan area, encompassing multiple cities, where the subscriber spends what could be the remaining 70% of their time. Notification 206, including “$P(2,1) Before Migration” (such as $7) and “$P(2,2) After Migration,” (such as $1) is associated with the Houston metropolitan area, illustrating the substantial potential cost savings after migrating the subscriber to the mobile virtual network operator's own network infrastructure. In this scenario, the cost after migration is significantly lower than the cost before migration. This cost reduction can stem from the mobile virtual network operator's direct ownership of network infrastructure in Houston, eliminating the need to lease capacity from a third-party mobile network operator and thereby avoiding associated roaming charges and potentially benefiting from more favorable data rates.

The figure emphasizes the challenge faced by the mobile virtual network operator in making a network switch decision for this subscriber. By way of illustrative example, while migrating the subscriber to the mobile virtual network operator's own network in Houston would yield significant cost savings, doing so would also lead to increased costs in the other location where the subscriber spends what could be 30% of their time. The mobile virtual network operator may weigh these competing factors, considering the subscriber's overall usage patterns and the long-term implications of each potential decision. A comprehensive cost-benefit analysis, factoring in the subscriber's usage distribution across both locations, is helpful to determine whether a network switch would be financially advantageous for the mobile virtual network operator.

This scenario also highlights the mobile virtual network operator's strategic considerations regarding network infrastructure expansion and optimization. The higher costs associated with serving the subscriber in the location outside of Houston can motivate the mobile virtual network operator to invest in expanding its own network coverage in that area. By doing so, the mobile virtual network operator can potentially reduce its reliance on third-party mobile network operators, gain greater control over its service delivery, and unlock additional cost savings opportunities for subscribers who frequent that location. The mobile virtual network operator can leverage data such as that shown in FIG. 2 to prioritize its infrastructure investments, focusing on areas where subscriber usage is high and the potential for cost savings is significant. This data-driven approach to network expansion and optimization can enhance the mobile virtual network operator's competitiveness and improve its long-term financial sustainability (see also the discussion of FIGS. 13-16).

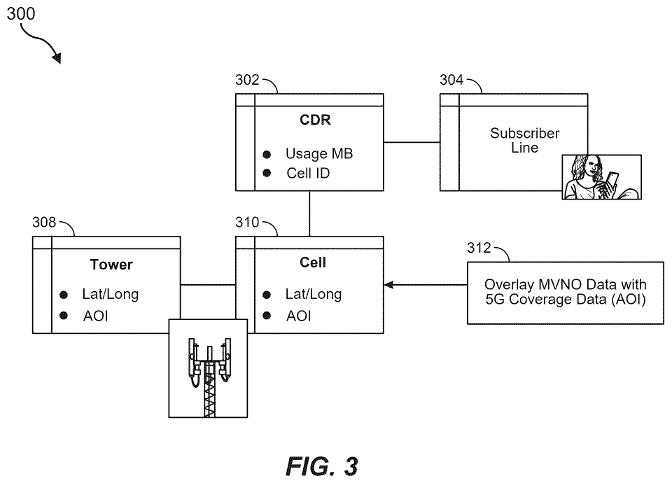

FIG. 3 shows a diagram 300 illustrating how a mobile virtual network operator can combine and analyze its internal data with external fifth generation (5G) wireless coverage data to gain a comprehensive understanding of subscriber usage patterns and network coverage. This process can enable the mobile virtual network operator to make more informed decisions about network switching, infrastructure investments, and service improvements, particularly in the context of leveraging its own 5G network infrastructure. The central component of diagram 300 can be description 312 indicating “Overlay mobile virtual network operator data with fifth generation wireless coverage data (area of interest). ” This element can represent the core functionality of the process, where the mobile virtual network operator integrates various data sources to create a detailed map of subscriber activity and network availability.

Several data inputs can contribute to this central process. Call detail record 302 can provide information about subscriber activity on the network, including call duration, data usage, and the time and potentially imperfect or imprecise location information for network connections. Call detail record 302 can be provided by a third-party mobile network operator that is serving clients for the mobile virtual network operator in accordance with an agreement. This data can be helpful for understanding how subscribers utilize the network and can be used to identify patterns and trends in usage behavior. Additional inputs can include metrics such as data usage, which can represent the quantity of data consumed by subscribers. This metric can be helpful for analyzing data usage patterns and understanding the demand for data services across different areas and subscriber segments. Additional inputs can also include codes that identify individual cell towers or sectors within the network. This information can be helpful for geolocation purposes, as it can allow the mobile virtual network operator to link subscriber activity to specific cell towers and, consequently, their geographic locations. Subscriber line 304 can be a line provided to the subscriber by the mobile virtual network operator.

Tower 308 can provide the geographic coordinates of each cell tower, which can be helpful for mapping subscriber activity to specific locations. This information can be obtained by matching cell identifier information with external databases or by utilizing location data provided by the mobile network operator partners. Cell 310 can refer to a specific cell from among the cells on a particular tower.

The integration of all these data elements within diagram 300 can allow the mobile virtual network operator to create a detailed and dynamic view of its network landscape. By combining internal subscriber data with external 5G coverage data, the mobile virtual network operator can accurately pinpoint the locations of its subscribers, analyze their usage patterns in relation to available network infrastructure, and identify opportunities for optimization. This process can be particularly valuable for mobile virtual network operators that are building out their own 5G networks, as it can enable them to strategically target their infrastructure investments and network switching efforts to maximize coverage, capacity, and cost efficiency.

The overlay of mobile virtual network operator data with 5G coverage data, particularly within specific areas of interest, can enable granular analysis of network performance and subscriber behavior. This can help identify regions where the mobile virtual network operator's own 5G network can provide superior coverage or capacity compared to its partner networks, justifying network switching decisions for subscribers in those areas. Conversely, the analysis can reveal locations where partner networks still offer better coverage or where the mobile virtual network operator's 5G network is not yet available, informing decisions to maintain existing network arrangements or prioritize infrastructure expansion in those areas.

The process depicted in diagram 300 can also highlight the mobile virtual network operator's strategic approach to managing its relationships with partner mobile network operators. By continuously monitoring subscriber usage patterns and comparing them to the coverage provided by different partner networks, the mobile virtual network operator can identify opportunities to renegotiate roaming agreements, optimize network utilization across partners, and potentially transition more subscribers to its own network infrastructure as its 5G coverage expands. This dynamic approach to network management can allow the mobile virtual network operator to adapt to evolving market conditions, technology advancements, and subscriber needs, ultimately striving to deliver high-quality, cost-effective, and reliable service to its customers.

FIG. 4 shows a diagram 400 that can illustrate a series of filters and checks that a mobile virtual network operator can apply to identify suitable candidates for a network switch onto the mobile virtual network operator's own mobile network operator infrastructure. This figure can demonstrate a decision-making process involved in optimizing network resources and improving service quality for subscribers. The process of identifying suitable candidates for network switching can be useful for the mobile virtual network operator to maximize the benefits of its own network infrastructure while maintaining high levels of service quality for its subscribers. The figure can show a funnel-like structure, with each level representing a different filter or check that narrows down the pool of potential candidates for the network switch.

Filter 402 can represent a numerical value associated with a corresponding filter, as discussed further below. At the top of the funnel, we can see total MVNO 408. By way of illustrative example, this could indicate that the mobile virtual network operator could have a total particular number of subscribers across all of its partner networks. Geolocatable 410 can represent a filter that can select or exclude certain subscribers based on their ability to be geographically located. For example, one mobile network operator partnering with the mobile virtual network operator may provide call detail records that enable the corresponding subscribers to be geolocated, whereas the agreement with another mobile network operator partnering with the mobile virtual network operator may not provide such information due to preference or technical incompatibility, for example.

Compatible devices overall 412 can be a filter that can ensure that only subscribers with devices that are technically compatible with the mobile virtual network operator's own network infrastructure are considered for the switch. Device compatibility can be a requirement for successful network switching, as incompatible devices may not be able to connect to or fully utilize the new network's capabilities. Compatible-migration tested 414 can be a filter that can represent a subset of subscribers whose devices have been specifically tested and confirmed to work with the migration process. This additional level of verification can help the mobile virtual network operator reduce the risk of service disruptions during the network switch. Tenure>three months 416 can be a filter that can focus on subscribers with a longer tenure, such as by using a particular threshold cut off (e.g., three months), so the mobile virtual network operator can prioritize more established customers for the network switch. Customers with a shorter tenure may be vulnerable to churning or abandoning the mobile virtual network operator, and the data associated with such customers may be so incomplete that it does not meaningfully facilitate the network switch decision-making process.

Data usage>4 GB/month 418 can be a filter that can target high-data users, so the mobile virtual network operator can potentially achieve cost savings and network optimization benefits from the switch based on the usage being higher than a threshold. By way of illustrative example, Estimated savings>$2/month 420 could be a filter that can ensure that each network switch results in a cost reduction, beyond a threshold, so the mobile virtual network operator can justify the effort and potential risks associated with the switching process. Launched AOIs 422 can be a filter that can ensure that the subscribers are located in areas where the mobile virtual network operator's own network infrastructure is available and operational. Compatible plans and VAS 424 can be a filter that can ensure that the subscribers' current plans and value-added services can be replicated or improved on the mobile virtual network operator's own network infrastructure. Compatible SW and SIM 426 can be a filter that can ensure that the subscribers' devices have compatible software and subscriber identity module cards that can work with the mobile virtual network operator's network. This check can be helpful for a smooth transition and can help prevent service interruptions during and after the switch. Voicemail 428 can be a filter that can ensure that subscribers' voicemail services can be properly transferred or reconfigured on the new network.

The filters shown in FIG. 4 can be applied in various orders or combinations, depending on the mobile virtual network operator's specific priorities and technical capabilities. The process can also be dynamic, with the mobile virtual network operator potentially adjusting the criteria or thresholds based on ongoing analysis and changing network conditions. The filtering process depicted in FIG. 4 can demonstrate the complexity of the mobile virtual network operator's approach to network switching. By selecting candidates based on multiple criteria, including device compatibility, usage patterns, potential cost savings, and geolocation capabilities, the mobile virtual network operator can increase the chances of successful network switches while reducing potential disruptions to subscriber services. This approach to candidate selection can be useful for the mobile virtual network operator to effectively leverage its own network infrastructure.

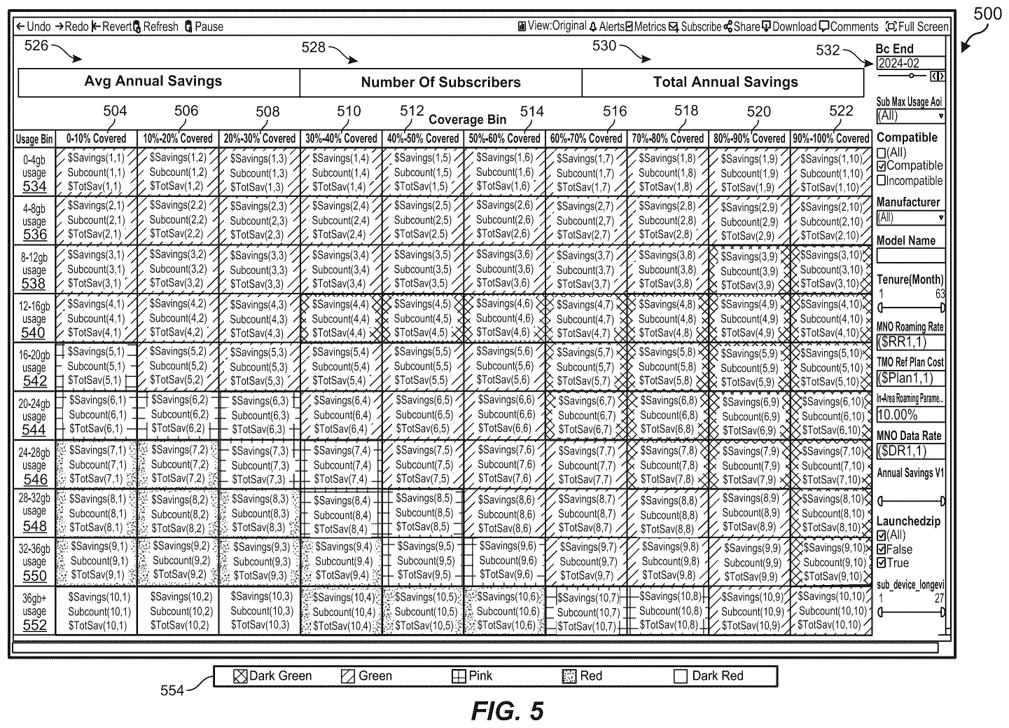

FIG. 5 shows a diagram 500 that illustrates a graphical user interface that presents data related to the network switching process for a mobile virtual network operator. The interface can display various metrics and data points that can be used to determine whether to perform a network switch for subscribers. The interface can show a two-dimensional graph with data indicating an average annual savings 526, a number of subscribers 528, and total annual savings 530. In some examples, the data can be specific to a particular billing cycle, as indicated by label 532.

The data presented in the graphical user interface can be based on a 30-day analysis period, which provides a view of subscriber behavior that balances recent trends with longer-term patterns. In some cases, the mobile virtual network operator may use shorter periods for subscribers with less historical data. This flexibility in analysis period allows for more responsive decision-making, particularly for newer subscribers or those who have recently altered their usage patterns. The choice of analysis period can significantly impact the assessment of subscriber behavior and potential cost savings. A longer analysis period may provide more stable data but could miss recent changes in subscriber behavior, while a shorter period may be more responsive to current trends but could be influenced by temporary anomalies. The mobile virtual network operator may adjust this analysis period based on various factors, including the overall stability of their subscriber base, the rate of change in network infrastructure, and the frequency of changes in partner network agreements.

The usage bins, such as usage bin 534, usage bin 536, usage bin 538, usage bin 540, usage bin 542, usage bin 544, usage bin 546, usage bin 548, usage bin 550, and usage bin 552, can represent different ranges of data consumption by subscribers. For example, usage bin 534 can represent subscribers who use between 0 and 4 gigabytes of data per month. These usage bins can allow the mobile virtual network operator to analyze subscriber behavior in relation to different coverage areas. The coverage bins, including coverage bin 504, coverage bin 506, coverage bin 508, coverage bin 510, coverage bin 512, coverage bin 514, coverage bin 516, coverage bin 518, coverage bin 520, and coverage bin 522, can correspond to the percentage of time that a subscriber's usage would have been covered by the mobile virtual network operator's own infrastructure according to a simulation, as discussed further below and consistent with method 100A. For instance, coverage bin 522 can indicate that, for the subscribers in that bin, the mobile virtual network operator's network would have covered between 90% and 100% of the subscriber's usage according to the simulation. The usage bins and coverage bins can intersect at cells, which each respectively indicate a value $Savings indexed to that particular row and column as the value of savings per subscriber, a value Subcount as the number of subscribers at that particular row and column, and a value $TotSav as the total amount of savings computed by multiplying $Savings by Subcount.

The interface can display average annual savings 526 for each combination of usage bin and coverage bin. This metric can help the mobile virtual network operator quantify the potential cost reductions that can be achieved by switching subscribers from a partner network to the mobile virtual network operator's own network in different scenarios. Number of subscribers 528 can show the count of subscribers that fall into each combination or permutation of usage bin and coverage bin. This information can help the mobile virtual network operator understand the distribution of their subscriber base across different usage and coverage scenarios. Total annual savings 530 can be calculated by multiplying average annual savings 526 by number of subscribers 528 for each combination or permutation of usage bin and coverage bin. This metric can provide an overall view of the potential cost savings that can be achieved by performing network switches for subscribers in different scenarios.

The interface can include additional filters and parameters that can be adjusted to refine the analysis. These include options to filter by billing cycle, specific areas of interest, device compatibility, subscriber tenure, and various cost factors such as roaming rates and network operation costs. These filters allow the mobile virtual network operator to perform highly targeted analyses and scenario planning. For example, the billing cycle filter can be used to focus on specific time periods, which may be useful for seasonal analyses or for examining the impact of particular events or promotions. The device compatibility filter can help identify subscribers whose devices may not be fully compatible with the mobile virtual network operator's network, potentially influencing the decision to switch or highlighting opportunities for device upgrade promotions. The subscriber tenure filter can be used to focus on long-term subscribers who may be more stable and thus better candidates for network switching. Cost factor adjustments allow for dynamic modeling of different scenarios, such as changes in roaming agreements or fluctuations in network operation costs, enabling the mobile virtual network operator to prepare for various future scenarios and make more robust long-term plans.

The system can take into account factors such as subscriber tenure, often excluding subscribers who have been with the service for less than 90 days. This helps avoid unnecessary network switches for subscribers who may have a higher likelihood of churning in the near term. The 90-day threshold is based on observed patterns in subscriber behavior, where the risk of churn is generally higher in the initial months of service. By focusing on more established subscribers, the mobile virtual network operator can prioritize network switches for those more likely to remain customers and thus provide longer-term cost savings. The interface can be used to analyze potential savings for subscribers with incompatible devices, helping to identify opportunities for targeted device upgrade campaigns that could enable beneficial network switches. This analysis might reveal situations where the potential long-term savings from a network switch could justify offering a subsidized device upgrade to a subscriber. Additionally, the system considers the longevity of the subscriber's device, which can indicate the likelihood of an imminent upgrade. This information can be particularly valuable when assessing subscribers with incompatible devices, as it helps prioritize outreach for device upgrades that would enable profitable network switches.

The mobile virtual network operator can use this data to make decisions about performing network switches. By analyzing the proportion of time spent by subscribers in locations covered by the mobile virtual network operator's own network (as represented by the coverage bins) and considering their data usage patterns (as represented by the usage bins), the mobile virtual network operator can identify subscribers who may benefit from a network switch. For example, subscribers who spend a significant proportion of time in high-coverage areas (e.g., coverage bin 522) and have low data usage (e.g., usage bin 534) may be candidates for a network switch. The mobile virtual network operator can calculate the potential cost savings for these subscribers based on average annual savings 526 and make a data-driven decision to perform the network switch.

The graphical user interface can provide an interactive way for the mobile virtual network operator to explore and analyze the data. The interface can include various controls and filters that allow users to customize the view and focus on specific subsets of data. For instance, users can select specific usage bins or coverage bins to examine the data in more detail. FIG. 5 also shows a legend 554 indicating the color or hatching for each combination of usage bin and coverage bin, with darker shades of green representing higher savings and redder colors showing losses, with a light beige/red line between these two portions indicating a breakeven point.

In general, FIG. 5 helps to show how the mobile virtual network operator can display a graphical user interface that includes a two-dimensional graph with one axis indicating a scale along which the proportion of time is measured. This graphical interface can provide a visual representation of the data used in making network switching decisions.

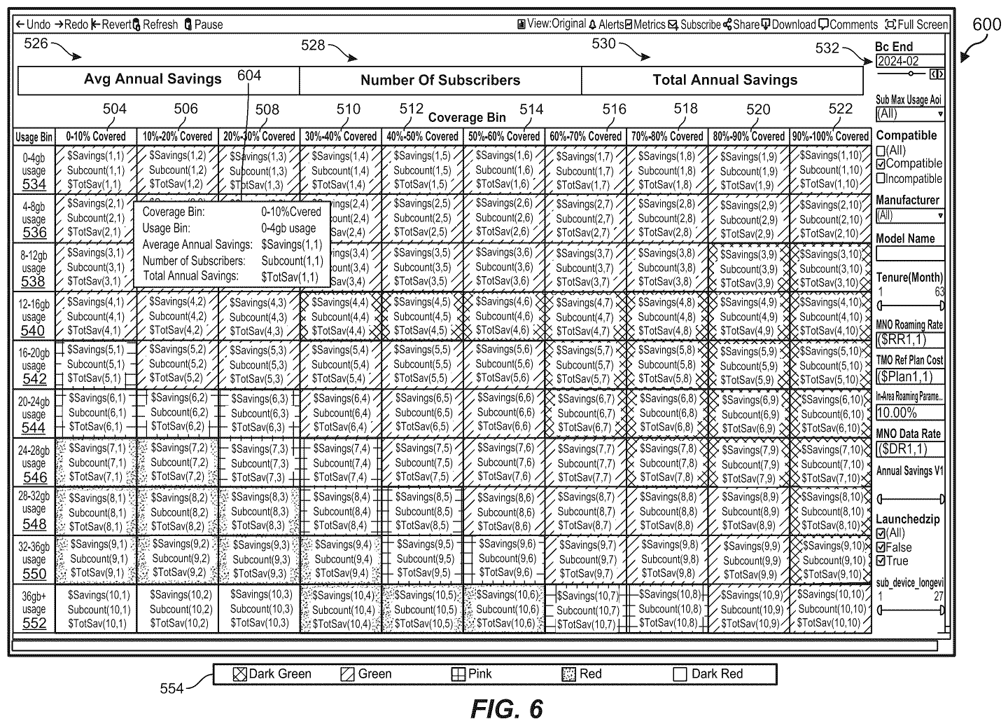

FIG. 6 shows a diagram 600 that can illustrate a modified view of the graphical user interface presented in FIG. 5, highlighting specific data points and providing additional context through a popup message 604. This figure can demonstrate how the mobile virtual network operator can interact with the data to gain more detailed insights into potential network switching opportunities and associated cost savings.

The primary difference between FIG. 6 and FIG. 5 can be the presence of a popup message 604 that includes corresponding information for a selected coverage bin and usage bin combination. This popup can appear when a user selects or hovers over a specific data point in the interface. The popup can provide more detailed information about a particular combination of usage bin and coverage bin, allowing the mobile virtual network operator to examine specific scenarios more closely. In the case shown in FIG. 6, the popup can focus on the “0-4 gb usage” bin 534 and coverage bin 504. The popup can display key metrics such as the average annual savings, number of subscribers, and total annual savings for this specific combination. This level of detail can be particularly useful for the mobile virtual network operator when making decisions about which subscribers to prioritize for network switching.

The presence of this pop-up message 604 in FIG. 6 can illustrate how the mobile virtual network operator can drill down into the data presented in the broader overview of FIG. 5. While FIG. 5 can provide a comprehensive view of all usage and coverage bins, FIG. 6 can show how the mobile virtual network operator can focus on specific scenarios of interest. This ability to isolate and examine particular combinations of usage and coverage can be valuable for the mobile virtual network operator in identifying the most promising opportunities for network switching. For example, by closely examining the data for low-usage subscribers in high-coverage areas, the mobile virtual network operator can potentially identify a group of subscribers who could be switched to the mobile virtual network operator's own network infrastructure with minimal risk and maximum cost savings.

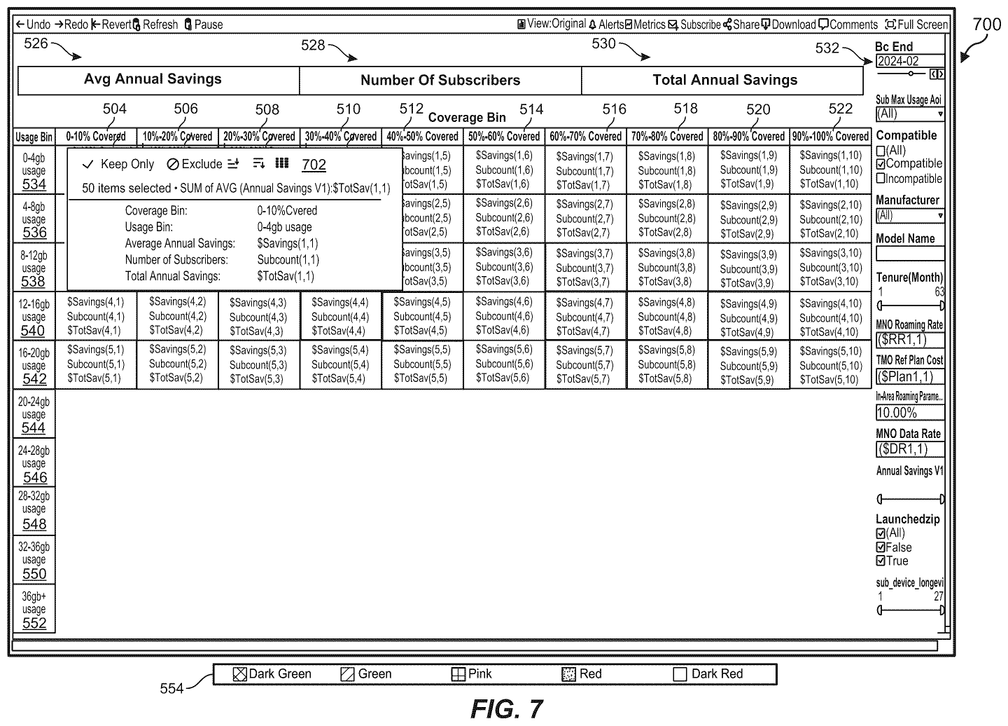

FIG. 7 shows a diagram 700 that presents a modified view of the graphical user interface introduced in FIG. 5, illustrating a scenario where specific data points have been selected for closer analysis. The cells that remain visible in FIG. 7 represent the intersection of selected usage bins and coverage bins. Popup notification 702, for example, can illustrate how the mobile virtual network operator can examine specific scenarios in more detail. The “Keep Only” button can allow the mobile virtual network operator to filter the displayed data to show only the selected data points, while the “Exclude” button can remove the selected data points from the view. The text “50 items selected” can indicate that the mobile virtual network operator has chosen 50 specific combinations of usage bins and coverage bins for closer examination. By way of illustrative example, the value “$TotSav(1,1),” labeled as “SUM of AVG (Annual Savings V1),” could represent the total average annual savings for all 50 selected items. This value can be calculated by summing the average annual savings for each of the 50 selected bin combinations.

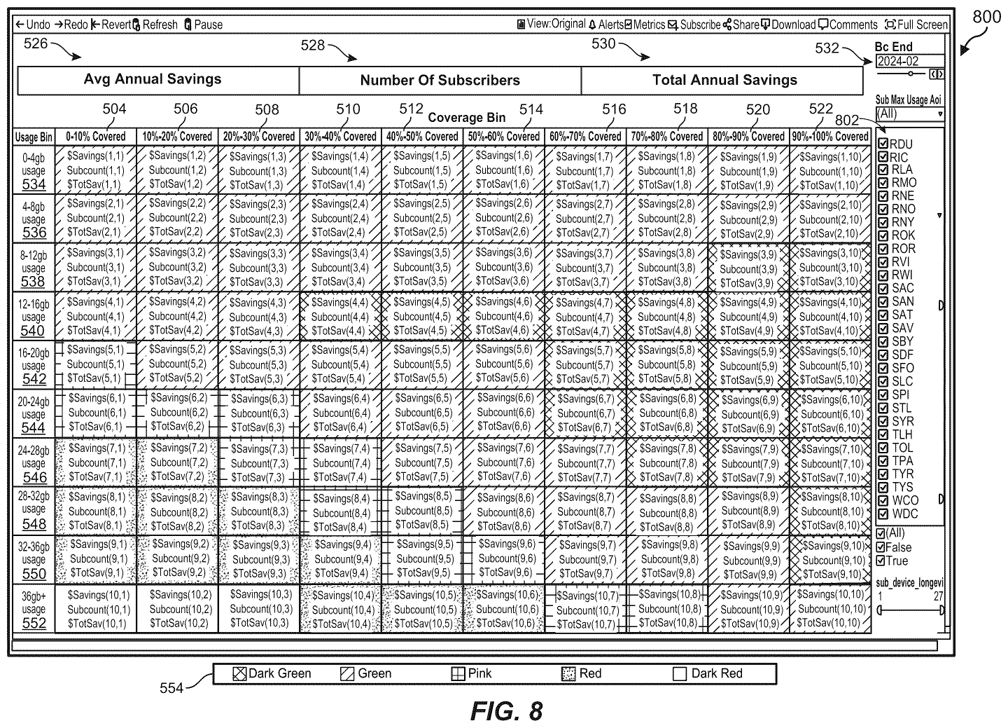

FIG. 8 shows a diagram 800 that can illustrate a modified view of the graphical user interface presented in FIG. 5, focusing on the area of interest selector 802. This selector can allow the mobile virtual network operator to filter and analyze data based on specific geographic regions, known as areas of interest. The areas of interest can be predefined by the mobile virtual network operator based on various factors such as population density, subscriber concentration, network coverage, or business priorities. By selecting specific areas of interest, the mobile virtual network operator can gain insights into subscriber behavior, network performance, and potential opportunities for optimization within those regions.

The area of interest selector can be used for managing network operations. It allows the mobile virtual network operator to temporarily exclude certain areas from network switching operations during planned maintenance or upgrades, ensuring that subscribers are not switched to a network that may experience temporary disruptions. This capability can be helpful for maintaining service quality and subscriber satisfaction during periods of network modification or expansion. For instance, if a particular city is undergoing a major network upgrade, the mobile virtual network operator may choose to pause network switches in that area until the upgrade is complete and stable. The area of interest selector can also be used to focus on specific regions for targeted network optimization efforts. By analyzing the data for a particular area of interest, the mobile virtual network operator can identify localized trends or issues, such as areas with unexpectedly high roaming costs or regions where network switches have been particularly successful. This granular view can inform decisions about network infrastructure investments, local marketing strategies, or partnerships with regional mobile network operators.

The area of interest selector 802 can display a list of areas, each represented by a three-letter code. These codes can correspond to specific geographic regions, such as cities, states, or custom-defined zones. For example, “SAC” can represent Sacramento, California, while “SLC” can denote Salt Lake City, Utah. The mobile virtual network operator can define these areas of interest based on their network coverage, subscriber distribution, or strategic importance. By clicking on the checkboxes next to each area of interest, the user can select or deselect specific regions to include or exclude from the analysis.

When an area of interest is selected, the graphical user interface can update the displayed data to reflect only the information relevant to that specific region. This can include metrics such as the average annual savings 526, number of subscribers 528, and total annual savings 530 for the selected area. By focusing on specific areas of interest, the mobile virtual network operator can identify trends, challenges, and opportunities unique to each region. This granular analysis can inform targeted strategies for network optimization, marketing campaigns, or partnerships with local mobile network operators.

For instance, if the mobile virtual network operator selects the area of interest “NYC,” representing New York City, the graphical user interface can display data specific to that region. This can reveal insights such as a high concentration of subscribers, significant potential for annual savings, or network performance issues specific to the New York City area. Based on this information, the mobile virtual network operator can prioritize network improvements, targeted marketing efforts, or partnerships with mobile network operators that have a strong presence in the New York City market.

The area of interest selector 802 can also support the selection of multiple areas simultaneously. By selecting multiple checkboxes, the mobile virtual network operator can compare and analyze data across different regions. This comparative analysis can reveal patterns, similarities, or differences in subscriber behavior, network performance, or savings potential across various geographic areas. For example, by selecting both “LAX” (Los Angeles) and “SFO” (San Francisco), the mobile virtual network operator can compare the metrics and trends between these two major California markets, identifying opportunities for regional optimization or resource allocation.

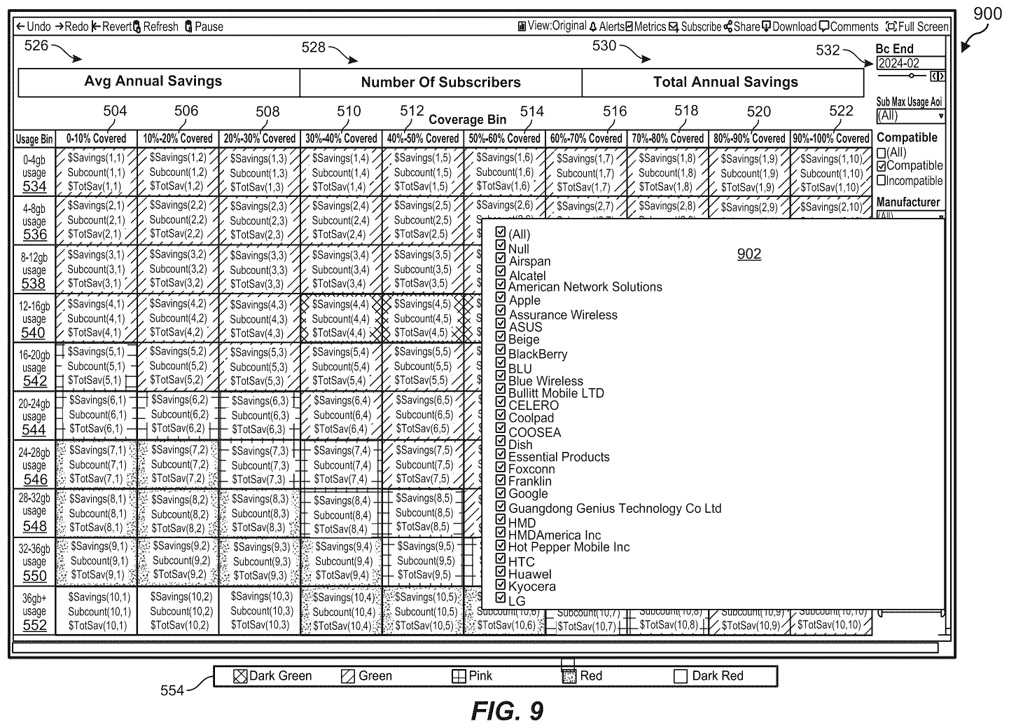

FIG. 9 shows a diagram 900 of a modified view of the graphical user interface introduced in FIG. 5, with a specific emphasis on the manufacturer selector 902. This selector can enable the mobile virtual network operator to filter and analyze data based on the device manufacturers associated with their subscribers. By examining metrics and trends specific to each manufacturer, the mobile virtual network operator can gain valuable insights into device-related factors that impact network performance, subscriber experience, and overall business strategies.

The manufacturer selector is useful for identifying opportunities related to device upgrades. It can help identify subscribers using older or incompatible devices who might benefit from a device upgrade before a network switch. This information can be used to target upgrade campaigns, potentially offering subsidized devices to subscribers whose switch would provide significant cost savings. By correlating device manufacturers with other data points such as usage patterns and coverage areas, the mobile virtual network operator can develop nuanced strategies for device upgrades and network switches. For example, they might identify that users of a particular manufacturer's devices tend to consume more data in certain areas, making them prime candidates for network switches in those regions. Alternatively, they might discover that certain device models are more likely to experience connectivity issues in specific coverage scenarios, informing decisions about whether to switch those users or prioritize them for device upgrades. This level of manufacturer-specific analysis can also inform negotiations with device manufacturers, potentially leading to partnerships or co-marketing opportunities that align with the mobile virtual network operator's network switching strategies.

The manufacturer selector 902 can present a list of device manufacturers relevant to the mobile virtual network operator's subscriber base. By clicking on the checkboxes next to each manufacturer, the user can select or deselect specific brands to include or exclude from the analysis. This filtering capability allows the mobile virtual network operator to focus on the performance and impact of specific device manufacturers within their network.

When a manufacturer is selected, the graphical user interface can update the displayed data to reflect only the information pertaining to devices from that specific brand. This can include metrics such as the average annual savings 526, number of subscribers 528, and total annual savings 530 associated with subscribers using devices from the selected manufacturer. By analyzing data at the manufacturer level, the mobile virtual network operator can identify trends, challenges, and opportunities related to specific device brands. This information can be valuable for making decisions related to device compatibility, subscriber acquisition, and partnerships with device manufacturers.

For instance, if the mobile virtual network operator selects “Apple” from the manufacturer selector 902, the graphical user interface can display data specific to iPhone and iPad devices. This can reveal insights such as the proportion of subscribers using Apple devices, the average annual savings associated with these subscribers, or any device-specific performance issues. Based on this information, the mobile virtual network operator can prioritize compatibility testing and optimization efforts for Apple devices, tailor marketing campaigns to target Apple users, or negotiate partnerships or promotions with Apple to attract and retain subscribers.

The manufacturer selector 902 can also support the selection of multiple manufacturers simultaneously. By selecting multiple checkboxes, the mobile virtual network operator can compare and analyze data across different device brands. This comparative analysis can uncover patterns, similarities, or differences in subscriber behavior, network performance, or savings potential based on the device manufacturer. For example, by selecting both “Samsung” and “LG,” the mobile virtual network operator can compare the metrics and trends between these two popular Android device manufacturers, identifying opportunities for device-specific optimizations or targeted marketing efforts.

Furthermore, the manufacturer selector 902 can be used in conjunction with other filters and selectors available in the graphical user interface, such as the area of interest selector 802 shown in FIG. 8. By combining filters based on device manufacturer and geographic region, the mobile virtual network operator can perform an even more granular analysis. For instance, they can examine the performance and impact of specific device brands within a particular area of interest, such as comparing Apple and Samsung devices in the New York City market. This cross-referencing of data can provide deeper insights into the interplay between device manufacturers and regional factors, enabling more targeted and effective decision-making.

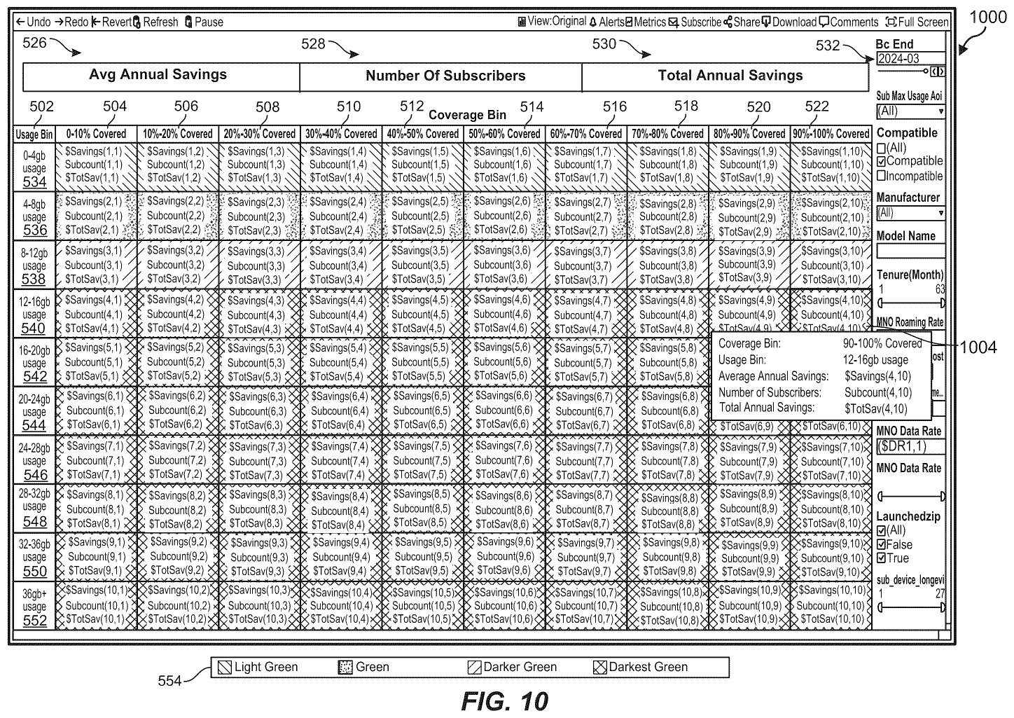

FIG. 10 shows a diagram 1000 that corresponds to FIG. 5, but after the MNO roaming rate 1004 has been altered, as discussed further below. Originally, in FIG. 5, the mobile network operator roaming rate 1004 was ($RR1,1), as an arbitrary example such as $1.32, which resulted in a color scheme that primarily featured both greenish and reddish cells, indicating both desirable or profitable network switches (more green) and undesirable or unprofitable ones (more red). This lower profitability can be attributed in part to the high roaming costs associated with the original ($RR1,1) rate. When a subscriber roams onto a partner network, the mobile virtual network operator often incurs charges from that partner network. These charges can quickly accumulate, especially for subscribers with high data usage or those who frequently travel outside the coverage area of the mobile virtual network operator's own network infrastructure. This high cost of roaming can significantly diminish the financial benefits of switching a subscriber to the mobile virtual network operator's network, as the savings from using the mobile virtual network operator's own infrastructure might be offset by the expenses incurred through roaming. Consequently, the color scheme in the original scenario reflected a limited number of profitable network switching opportunities, as high roaming costs made it difficult to achieve substantial cost savings.

However, as an arbitrary example for illustrative purposes, if the roaming rate 1004 was reduced to $0.10, the entire color scheme of the graph shifted dramatically towards green, signifying a substantial increase in potential savings across all usage and coverage bins. This dramatic transformation in profitability can be explained by the impact of roaming costs on the overall cost structure of the mobile virtual network operator. When the roaming rate was high, the mobile virtual network operator incurred substantial expenses whenever subscribers roamed onto partner networks, even if those subscribers spent a significant proportion of their time within the coverage area of the mobile virtual network operator's own infrastructure. These high roaming costs often outweighed the potential savings from using the mobile virtual network operator's native network infrastructure, resulting in low overall profitability for network switches.

However, in this illustrative example, the reduction in roaming rate 1004 to what could be $0.10 significantly altered this cost dynamic. The lower roaming charges meant that the mobile virtual network operator could now realize substantial cost savings by migrating subscribers to its own network, even in cases where subscribers might occasionally roam onto partner networks. The reduced roaming costs made network switching financially attractive for a much broader range of usage and coverage scenarios, as reflected in the predominantly green color scheme in FIG. 10. This shift highlights the sensitivity of network switching profitability to roaming rates, demonstrating how a significant reduction in this parameter can unlock numerous profitable migration opportunities that were previously uneconomical.

FIGS. 11A and 11B show a workflow diagram 1100 that collectively illustrates a detailed chronology of steps that can be involved in enabling a new subscriber identity module profile and porting a subscriber's telephone number to a new network, as part of the network switching process. The diagram presents a comprehensive view of various stages that can be involved, from initiating the switch to completing the transition and helping to ensure a positive experience for the subscriber, without relying on Wi-Fi connectivity.

The process can begin at step 1102, such as when the mobile virtual network operator's order management (OM) system 1100 receives a request 1102 to switch a subscriber's network from a first mobile network operator (MNO1) to a second mobile network operator (MNO2). This request can be triggered by various factors, such as the mobile virtual network operator's analysis of the subscriber's usage patterns, coverage requirements, or potential cost savings, as discussed in relation to previous figures. For example, FIG. 2 indicates actual MVNO subscriber usage locations that the mobile virtual network operator may use to analyze subscriber usage patterns, and the mobile virtual network operator may initiate a network switch based at least in part on the analysis of these locations.

At the start of workflow diagram 1100, the mobile virtual network operator can proceed to register 1110 the subscriber's telephone number (TN) with the second mobile network operator (MNO2, which can correspond to the native mobile network operator of the mobile virtual network operator). This step can help route the subscriber's calls, messages, and data through the second mobile network operator's network infrastructure. By registering the telephone number (TN), the mobile virtual network operator can establish connections and configurations that can support the subscriber's services on the new network.

Following the telephone number (TN) registration, the mobile virtual network operator can initiate an audit 1112 of the subscriber's physical subscriber identity module (pSIM) to validate connectivity. This audit process can involve testing the physical subscriber identity module's (pSIM) compatibility with the second mobile network operator's (MNO2) network and ensuring that it can establish a connection. The audit may include various technical checks, such as verifying the subscriber identity module's authentication parameters, network settings, and signal strength. The physical subscriber identity module (pSIM) audit can help identify potential issues that could affect the subscriber's experience after the switch. For example, the mobile virtual network operator may audit the physical subscriber identity module (pSIM) card by sending a remote subscriber identity module provisioning (RSP) message. The physical subscriber identity module (pSIM) card can send a response message, and the mobile virtual network operator can confirm successful receipt of the response message. The audit may include sending a plurality of remote subscriber identity module provisioning (RSP) messages. For example, one message may check for compatibility of the physical subscriber identity module (pSIM) card with the second mobile network operator (MNO2) and another message may verify the network settings of the physical subscriber identity module (pSIM) card. The physical subscriber identity module (pSIM) card may send a plurality of response messages in response to receiving the plurality of remote subscriber identity module provisioning (RSP) messages.

Once the physical subscriber identity module audit is completed, and the mobile virtual network operator receives confirmation 1114 of successful connectivity, a subsequent step can include downloading 1116 the second mobile network operator's (MNO2) electronic subscriber identity module (eSIM) profile to the subscriber's physical subscriber identity module (pSIM) card. An electronic subscriber identity module (eSIM) (embedded subscriber identity module) can be a programmable subscriber identity module card that allows the subscriber's device to store and switch between multiple network profiles. By downloading the second mobile network operator's (MNO2) electronic subscriber identity module (eSIM) profile, the mobile virtual network operator can enable the subscriber's device to connect to the new network without requiring a physical subscriber identity module card replacement. For example, the mobile virtual network operator can send a download request message 1118 to the subscriber's physical subscriber identity module (pSIM), such as through a remote subscriber identity module provisioning (RSP) platform. The physical subscriber identity module (pSIM) can send a response back to the mobile virtual network operator, acknowledging the download request message 1118.

After the successful download of the new electronic subscriber identity module (eSIM) profile, the mobile virtual network operator can initiate a process for provisioning services on the new network 1120. The second mobile network operator (MNO2) can then execute a subprocess to provision the services to the subscriber's device, completing the service provisioning process. Upon completion of this step, the colors at the bottom of FIG. 11A change to reflect the legend, indicating that the subscriber's services have been successfully provisioned on the second mobile network operator (MNO2).

With the new electronic subscriber identity module (eSIM) profile in place, the mobile virtual network operator can then activate the second mobile network operator's (MNO2) subscription for the subscriber 1122. This activation process can involve configuring the necessary network settings, provisioning the subscriber's account, and ensuring that all services (voice, data, messaging) are properly enabled on the new network. Activating the subscription can mark a point at which the subscriber's device begins to utilize the second mobile network operator's network for their mobile services. The subscriber may not need to take any manual steps during this process, such as restarting their device or confirming the switch on their end.

Once the new subscription is activated, the mobile virtual network operator can initiate the process of porting 1124 the subscriber's telephone number to the second mobile network operator (MNO2). Number porting can be a step that helps ensure the subscriber retains their existing telephone number even after switching networks. The mobile virtual network operator can coordinate with both the old and new mobile network operators to transfer the telephone number, attempting to minimize any disruption to the subscriber's incoming and outgoing calls or messages. In the diagram, subscriber service availability 1126 indicates a chronological spectrum along which the status of the various time slices 1128-1158, 1182-1198, and 1101-1113 progress from left to right across the entirety of FIGS. 11A-11B, where the time slices have their statuses changed according to the legend shown in FIG. 11B.

After the mobile virtual network operator receives confirmation 1124 that the new subscription has been activated, a next step can involve porting the subscriber's telephone number (TN) to the new network. This process can be carefully orchestrated to help avoid any service interruption for the subscriber. In the specific scenario illustrated in FIGS. 11A-11B, the mobile virtual network operator can act as the winning carrier and can have a higher degree of control over the timing of the porting process.

The remote subscriber identity module provisioning platform (RSP) can receive 1162 confirmation of the successful profile switch. In response, the local number portability (LNP) platform can initiate 1164 the port-in to the second mobile network operator (MNO2), which can correspond to the native mobile network operator of the mobile virtual network operator. This communication can be considered an internal move order and can be distinct from a typical port-in process for new subscribers. The mobile virtual network operator can request the port out of the subscriber's telephone number, aiming to eventually transfer it to the second mobile network operator (MNO2). Order management 1160 can facilitate these steps by coordinating with the remaining subcomponents discussed above.

Upon completion of the second mobile network operator's (MNO2) service provisioning process, the Local Number Portability (LNP) platform can receive an indication 1166 that the porting process to the second mobile network operator (MNO2) has completed. At step 1168, the remote subscriber identity module provisioning (RSP) platform can register the telephone number to both the first mobile network operator's (MNO1) electronic subscriber identity module (eSIM) card and to the second mobile network operator's (MNO2) electronic subscriber identity module (eSIM) card.

The remote subscriber identity module provisioning (RSP) platform can set the second mobile network operator (MNO2) as the fallback profile within the electronic subscriber identity module (eSIM) 1172. This can ensure that the device can connect to the second mobile network operator's (MNO2) network even if the primary profile (e.g., the first mobile network operator's (MNO1) profile) experiences any issues. The remote subscriber identity module provisioning (RSP) platform can indicate 1174 confirmation of successful fallback profile change to the second mobile network operator (MNO2). Once this confirmation is received, the mobile virtual network operator can be confident that the fallback profile has been properly configured.

At step 1176, the remote subscriber identity module provisioning (RSP) platform can delete the first mobile network operator (MNO1) profile from the physical subscriber identity module (pSIM) card. This deletion can free up space on the physical subscriber identity module (pSIM) card and can prevent any potential conflicts or confusion between the old and new network profiles. Finally, at step 1178, the remote subscriber identity module provisioning (RSP) platform can indicate confirmation of successful first mobile network operator (MNO1) profile deletion. This final confirmation helps ensure that the old network profile has been completely removed from the physical subscriber identity module (pSIM) card, marking the successful completion of the network switching process. After the chronology outlined above, the corresponding method can end at a step 1113.

In view of the above, FIGS. 11A-11B help to illustrate how the network switch, when performed, can be executed invisibly by switching an active profile on a subscriber identity module for the client from a first profile that is specific to the first network infrastructure of the first mobile network operator to a second profile that is specific to the second network infrastructure of the second mobile network operator. This can involve switching an active profile on a subscriber identity module card of the client from a first profile corresponding to the first network infrastructure to a second profile corresponding to the second network infrastructure.

FIG. 12 shows a diagram 1200 that provides a high-level overview of steps that can be involved in enabling a new subscriber identity module profile and porting a subscriber's telephone number to a new network, as part of the network switching process. This figure highlights the interactions between the mobile virtual network operator, the digital operator platform (e.g., a centralized interface between the mobile virtual network operator and its retail components), and a specific third-party mobile network operator (e.g., MNO1) that provides cellular services to clients of the mobile virtual network operator in accordance with an agreement. At step 1202, the digital operator platform can initiate a migration script. At step 1204, the digital operator platform can validate eligibility for performing the network switch. At step 1206, the digital operator platform can create a new subscription with equivalent services to the subscription established with the losing mobile network operator prior to the performance of the network switch. At step 1208, the digital operator platform can initiate a native mobile network operator port in through a mobile virtual network enabler. At step 1210, the mobile virtual network enabler can call the native mobile network operator as part of the port-in request. At step 1212, the native mobile network operator can call its retail wireless component to check for the port-in or network switch. At step 1214, the new subscriber identity module profile can be downloaded to the subscriber's physical subscriber identity module card. At step 1216, the subscriber's services can be provisioned on the target network. At step 1218, the subscriber's new subscriber identity module profile can be enabled. At step 1220, the subscriber's telephone number can be ported into the target network. At step 1222, the losing mobile network operator can send a port out request to the mobile virtual network enabler. At step 1224, the mobile virtual network enabler can transmit a proxy port out notification from the losing mobile network operator to the retail wireless component of the mobile virtual network operator. At step 1226, the digital operator platform can transfer warranty and/or loan information to the newly created account. At step 1228, the digital operator platform can delete the old account. At step 1230, the digital operator platform can unlock the new account.

FIG. 13 shows a flow diagram that depicts a method 1300 relating to tower planning for a mobile virtual network operator, specifically focusing on optimizing tower placement for both coverage and subscriber migration. At step 1302, method 1300 can start or begin. At step 1304, method 1300 can include identifying coverage gaps and high-usage areas with subscriber-specific data. At step 1306, method 1300 can include simulating tower impact prior to placement. At step 1308, method 1300 can include prioritizing tower investments based on cost-benefit analysis, including network migration potential. Finally, method 1300 can terminate at step 1310.

Step 1304 can involve identifying areas where the network has limited coverage and where user demand is high. This step combines information about the location of existing towers with data about subscribers, such as their locations, their data usage patterns, and the costs associated with roaming. By combining this information, specific areas can be identified where the network has limited coverage, but a competing network offers strong coverage and high subscriber usage. These areas can be attractive for potential tower investments, as they present opportunities to improve coverage and potentially attract subscribers who could be profitably migrated to the network.

Step 1306 can involve simulating the effects of adding new towers or upgrading existing towers before actually placing them. This is a helpful part of the strategic tower planning process, as it allows for a comprehensive assessment of potential outcomes before committing to expensive infrastructure investments. The simulation model can combine various types of information: a representation of the existing network infrastructure, including signal strength and coverage areas; a model of how subscribers might respond to changes in coverage, taking into account factors such as coverage-based roaming costs and preferences; and a calculation of potential cost savings by simulating migrations based on identified high-usage areas and roaming patterns. This component can quantify the potential financial benefits associated with attracting subscribers from the competing network.

Furthermore, the simulation model can help evaluate the impact of adding new towers or upgrading existing towers on network performance and the feasibility of migrating subscribers. This analysis can consider the technical capabilities of the towers and their potential influence on signal strength and coverage. The simulation process can provide a detailed understanding of the technical aspects of tower placement and their potential impact on network performance. It can also assess the feasibility of migrating subscribers based on the simulated coverage changes. The simulation can help evaluate whether the improved coverage would enable cost-effective migration of subscribers from the competing network.

Finally, step 1308 can involve prioritizing potential tower projects based on a cost-benefit analysis that includes potentially network migration potential. This step can involve evaluating potential tower projects based on both the improvement in coverage provided by the new tower and the potential for increased subscriber migration. The cost savings analysis can estimate the potential savings from network migrations if a tower is deployed. This component can quantify the financial benefits associated with attracting subscribers to the network. The coverage impact analysis can evaluate the improvement in coverage provided by the new tower, taking into account signal strength and geographic reach. This analysis can provide a clear understanding of the geographic expansion enabled by the new tower.

The business value assessment can consider the long-term strategic value of the tower investment, taking into account factors like market penetration, customer acquisition, and overall network growth. This evaluation can consider the broader implications of the tower investment on the overall business strategy. The integration of network migration potential as a primary factor in the tower planning decision-making process can be a helpful part of this approach. This can align tower planning with the overall business goal, which can be to optimize network infrastructure for attracting subscribers and reducing costs. This approach can help ensure that tower investments are strategically aligned with long-term objectives, such as subscriber growth and cost optimization.

By integrating network migration into the tower planning process, this approach can help make more informed decisions that optimize network infrastructure for both coverage expansion and subscriber acquisition. This can lead to a more efficient and potentially more profitable network operation. This method can provide a strategic framework for maximizing the value of tower investments and achieving long-term business objectives.

FIG. 14 illustrates a geographic visualization 1400 that demonstrates how the data and analysis methods used for network switching decisions can be repurposed for tower planning. This visualization represents an application of the concepts and techniques discussed throughout this disclosure, showing how the same underlying principles can be applied to different aspects of network management and infrastructure development. The network switching concept, as detailed in FIG. 1A, involves detecting the proportion of time a client connects to different network infrastructures, simulating network switches, and calculating resource consumption to determine if a switch is beneficial. This same analytical framework can be applied to tower planning, where instead of deciding whether to switch a client's network, a decision can be made where to place new towers or optimize existing ones. In the context of tower planning, the visualization 1400 depicts cell sites operated by a mobile virtual network operator and their spatial relationship to cell sites operated by a third-party mobile network operator.

A metro area indicator headline 1402 and menu 1404 can enable a user to specify one or more particular metropolitan areas or areas of interest, such as “Sacramento (SAC). ” The value shown in distance to closest MNO tower 1406 represents a value in meters, such as 1000 meters, that specifies a cutoff in terms of how far a closest native mobile network operator tower can be to a point of interest (i.e., where a native mobile network operator corresponds to the native infrastructure of the mobile virtual network operator). Legend 1440 can explain the coloring or hatching used within the graphical user interface. Data usage indicator 1412 and corresponding scale 1414 can represent the total data usage for that particular site. MN1 roaming cost headline 1416 and corresponding scale 1418 can represent an amount of roaming cost through a third-party mobile network operator such as T-Mobile. False indicator 1420 and true indicator 1422 can enable the user to distinguish between true and false in view of the input components further discussed above. MN1 roaming cost headline 1424 can provide context for counts 1426 through 1434, which can be counts showing the number of MVNO sites that are less than 500 meters away, 500 meters to 1000 meters away, 1000 meters to 2000 meters away, and greater than 2000 meters away (although this example focuses on meters, any threshold amount of distance can be used and configurable). The site coverage area 1436 can be analyzed using these customer experience metrics to prioritize regions for tower development. Input component 1438 can allow the mobile virtual network operator to specify a particular site coverage area.

The geolocation techniques described in FIG. 1B for network switching can be directly applied to tower planning. By accurately geolocating user activities and network usage patterns, planners can identify high-demand areas that might benefit from additional tower coverage. Scale 1410, showing the distance between cell sites, leverages a parallel geospatial analysis used to determine client locations for network switching decisions. The customer experience evaluation methods outlined in FIG. 1C for post-switch analysis can be adapted for tower planning. Instead of detecting deficiencies after a network switch, these methods can be used to identify areas where current tower coverage is inadequate, informing decisions about where new towers might be needed. The device compatibility considerations discussed in FIG. 1D can also inform tower planning. Areas with a high concentration of devices that are compatible with advanced network technologies might be prioritized for tower upgrades or new installations to take full advantage of these capabilities.

By leveraging the same data and analytical methods used for network switching, tower planning can benefit from a rich, multidimensional understanding of network performance and user needs. For instance, the proportion of time calculation described in FIG. 1A can be adapted to determine what percentage of time users in a given area rely on third-party mobile network operator infrastructure due to gaps in the mobile virtual network operator's coverage. Areas with high percentages might be candidates for new tower installations. Similarly, the resource consumption calculations used to justify network switches can be applied to tower planning. Instead of comparing pre-and post-switch scenarios, planners can model the potential impact of new tower placements on overall network resource utilization. This approach allows for data-driven decisions about where infrastructure investments are likely to yield the greatest benefits in terms of improved coverage, reduced roaming costs, and enhanced user experience. The simulation techniques described for network switching can be adapted for tower planning as well. Planners can simulate the addition of new towers or the upgrading of existing ones, using the same types of data and analytical methods to predict the impact on network performance, user experience, and operational costs. This allows for thorough evaluation of different tower placement strategies before committing to costly infrastructure investments.

Moreover, the customer experience evaluation methods detailed in FIG. 1C can be particularly valuable in tower planning. By analyzing patterns of service deficiencies across geographic areas, planners can identify regions where new towers or upgrades to existing infrastructure could have the most significant impact on user satisfaction and retention. This approach ensures that tower planning is not done in isolation, but rather as part of a comprehensive strategy that considers network switching possibilities, user experience, device compatibility, and overall network optimization. The visualization in FIG. 14 supports this holistic approach by providing a clear, spatial representation of the network landscape, allowing planners to see at a glance where coverage gaps exist, where usage is highest, and where infrastructure investments might be most beneficial. By applying the analytical framework developed for network switching to tower planning, mobile virtual network operators can make more informed, strategic decisions about infrastructure development. This can lead to more efficient allocation of resources, better targeting of infrastructure investments, and ultimately, improved service quality for users.

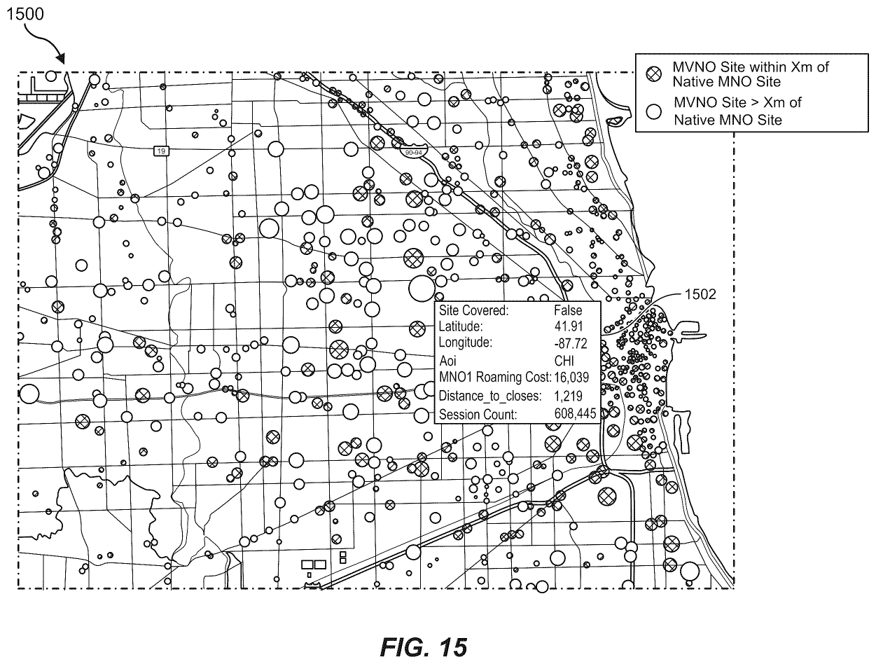

FIG. 15 illustrates a zoomed-in view of the geographic visualization 1500 introduced in FIG. 14, including a popup notification 1502, focusing on a specific area of interest to demonstrate how the integrated approach of network switching analysis and tower planning can be applied at a more granular level. This detailed view provides network planners with the ability to examine particular regions more closely, allowing for precise decision-making in both network switching strategies and tower placement. The visualization in FIG. 15 can depict a map or geographic representation of a particular area, in this case, potentially focusing on a major metropolitan area such as Chicago (CHI). This level of detail can be helpful for understanding the nuances of network performance and infrastructure needs in densely populated urban environments, where demand for network resources can be particularly high and the potential impact of network switches or new tower placements can be significant. The visualization continues to use different visual indicators to distinguish between cell sites operated by the mobile virtual network operator and those operated by the native mobile network operator, allowing for a clear understanding of the existing infrastructure landscape.

In the context of combined network switching and tower planning analysis, distances between cell tower sites can be particularly significant. For example, cell sites that are very close to each other might indicate areas where network switching could be an effective strategy to optimize resource utilization, while areas with sparse coverage might be candidates for new tower installations. The detailed view provided in FIG. 15 allows planners to see these relationships more clearly, facilitating more informed decision-making about whether to pursue network switching strategies or invest in new infrastructure in specific locations. This granular view can also help in identifying potential sites for new towers that could serve dual purposes: filling coverage gaps for the mobile virtual network operator while also providing opportunities for beneficial network switches in the future.

The visualization in FIG. 15 can show individual cell sites operated by the mobile virtual network operator, with each site represented by a distinct symbol or marker. These markers can provide detailed information about each site, such as its exact location, coverage area, and proximity to the nearest cell site operated by the native mobile network operator. This level of detail can be helpful for both network switching decisions and tower planning. For network switching, it can help identify areas where the mobile virtual network operator's coverage closely aligns with or significantly differs from the third-party mobile network operator's infrastructure. In terms of tower planning, this information can highlight areas where new towers might be needed to improve coverage or where existing towers might be upgraded to support more efficient network switching. The visualization can also include additional data points for each cell site, such as average user traffic, frequency of network congestion, or historical patterns of service quality. This information, which is valuable for both network switching decisions and tower planning, can be displayed through variations in the size, shape, or annotation of the cell site markers.

FIG. 15 can also incorporate elements that directly relate to the network switching analysis methods described earlier in the application. For instance, it could display heat map overlays showing the proportion of time users in different areas connect to the mobile virtual network operator's network versus the third-party mobile network operator's network, as calculated using the methods described in FIG. 1A. Areas with a high proportion of time spent on the third-party mobile network operator's network might be prime candidates for new tower installations by the mobile virtual network operator. Conversely, areas where users frequently switch between networks might benefit from optimized network switching protocols rather than new infrastructure. This type of integrated analysis, visually represented in FIG. 15, can help planners make more holistic decisions that consider both immediate network switching opportunities and long-term infrastructure needs. The visualization could also incorporate data from the customer experience evaluation methods outlined in FIG. 1C, such as indicators of service quality or user satisfaction across different areas. This information can be valuable for both identifying areas where network switches might improve user experience and for prioritizing locations for new tower installations.

The detailed view provided in FIG. 15 can also be particularly useful for applying the device compatibility considerations discussed in FIG. 1D to both network switching and tower planning decisions. For example, the visualization could include data on the types of devices commonly used in different areas of the city. This information could inform decisions about where to implement network switches based on device compatibility, as well as where to install new towers or upgrade existing ones to support advanced device capabilities. By integrating this device-related data into the geographic visualization, planners can ensure that both network switching strategies and infrastructure investments are aligned with the actual devices in use in different areas, maximizing the impact of these decisions on user experience and network performance. This level of detail can also help in planning for future technology upgrades, allowing the mobile virtual network operator to strategically position new towers or upgrade existing ones in areas where device trends suggest growing demand for advanced network capabilities.

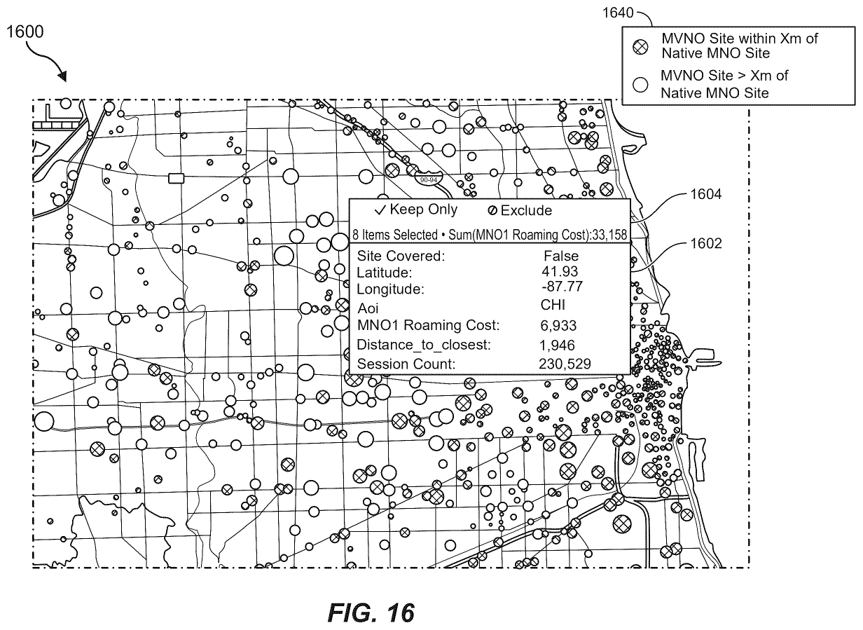

FIG. 16 shows a diagram 1600 that illustrates an alternative zoomed-in view of the visualization shown in FIG. 14, focusing on the same area of interest as shown in FIG. 15. This figure can provide a more detailed look at the relationship between mobile virtual network operator and third-party mobile network operator coverage in a specific geographic location, revealing insights relevant to network planning and optimization in that area. The visualization in FIG. 16 can display a map or geographic representation 1600 of a particular area. This area can be defined based on various factors such as population density, subscriber concentration, network coverage, or strategic importance. In this case, the area of interest can be Chicago (CHI), representing a major metropolitan area.

The visualization in FIG. 16 can show mobile virtual network operator cell sites and their location relative to the third-party mobile network operator cell sites. This can involve the use of different colors or symbols to visually distinguish between mobile virtual network operator and third-party mobile network operator cell sites. The visualization can include a color scale or legend 1640, which can help interpret the colors used in the visualization. The legend can provide information on the distance between mobile virtual network operator and third-party mobile network operator cell sites. The visualization can show different color shades or symbols depending on the distance between the mobile virtual network operator cell site and the closest third-party mobile network operator cell site. Popup notification 1602 can represent a popup notification that can provide detailed information about a selected mobile virtual network operator cell site. The popup notification 1602 can include information such as the coverage status of the cell site, the latitude of the cell site, the longitude of the cell site, an area of interest (AOI) where the cell site is located, the roaming cost associated with the cell site, the distance to the closest cell site (e.g., closest native cell site or closest third-party cell site), and a session count showing how many sessions have occurred at the cell site. For example, the popup notification 1602 in FIG. 16 shows that the coverage status for the selected site is false. Popup notification 1604 can provide the user with more information regarding selected sites, such as indicating the number of items selected (e.g., “8 items selected” in FIG. 16). Additionally, popup notification 1604 can enable the user to perform actions on the selected items, such as “keep only” or “exclude. ” FIG. 16 also illustrates how popup notification 1604 can display a summation of third-party mobile network operator roaming costs associated with the selected items.

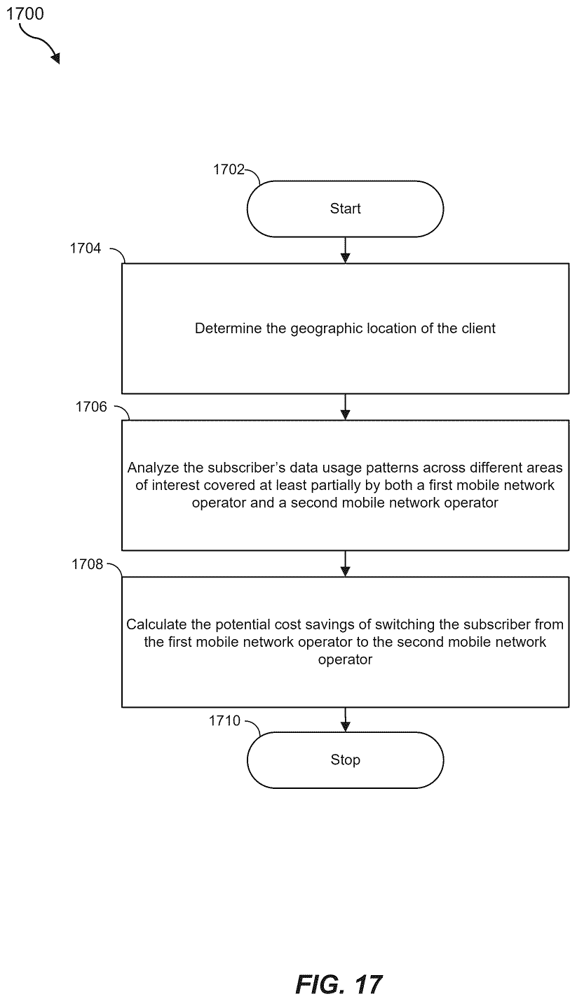

FIG. 17 shows a flow diagram for a method 1700 relating to analyzing and optimizing network usage for a mobile virtual network operator, specifically focusing on evaluating potential cost savings when switching subscribers between different mobile network operators. At step 1702, method 1700 can start or begin. At step 1704, method 1700 can include determining the geographic location of the client. At step 1706, method 1700 can include analyzing the subscriber's data usage patterns across different areas of interest covered at least partially by both a first mobile network operator and a second mobile network operator. At step 1708, method 1700 can include calculating the potential cost savings of switching the subscriber from the first mobile network operator to the second mobile network operator. Finally, method 1700 can terminate at step 1710.

Method 1700 begins with determining the geographic location of the client at step 1704. This step can be important for understanding the network coverage available to the subscriber and can involve various techniques such as analyzing call detail records (CDRs) or utilizing GPS data from the subscriber's device. In cases where explicit location data is not available, the mobile virtual network operator can employ sophisticated geolocation techniques, such as those described in relation to FIG. 18. This figure illustrates a comprehensive table that associates cell site identifiers with geographic location data and other relevant information. By matching cell identifiers from CDRs with this database, the mobile virtual network operator can accurately determine a subscriber's location even when this information is not directly provided in the usage data.

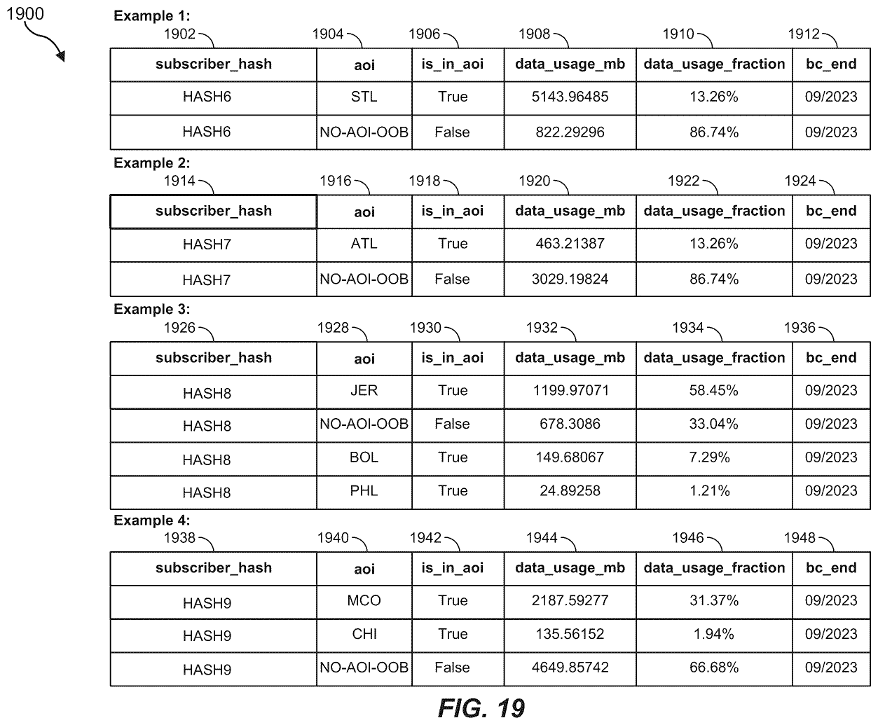

Once the subscriber's location is established, the method proceeds to step 1706, which involves analyzing the subscriber's data usage patterns across different areas of interest covered at least partially by both a first mobile network operator and a second mobile network operator. This step can be valuable for understanding how subscribers interact with the network across various geographic regions and can inform decisions about potential network switches. The analysis can involve examining metrics such as data consumption, voice call duration, and messaging frequency in different locations. FIG. 19 provides a detailed breakdown of this type of analysis, showing how subscriber usage can be categorized by area of interest. This granular view of usage patterns can help the mobile virtual network operator identify areas where network switching might be most beneficial, both in terms of cost savings and improved service quality for the subscriber.

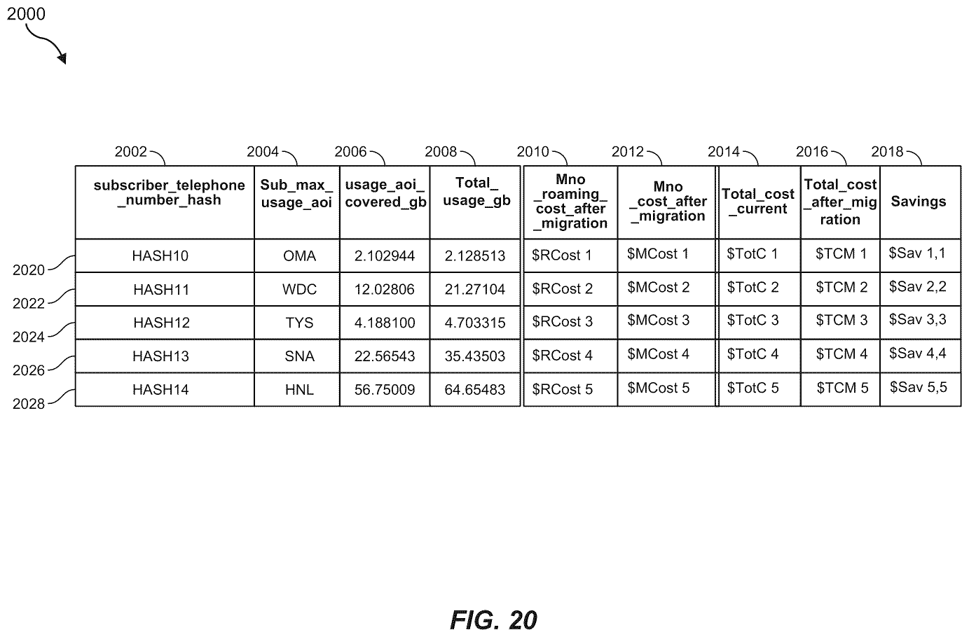

The final step of method 1700, represented by step 1708, involves calculating the potential cost savings of switching the subscriber from the first mobile network operator to the second mobile network operator. This calculation can take into account various factors, including the usage patterns identified in step 1706, the coverage quality of both network operators in the relevant areas, and the different cost structures associated with each network. FIG. 20 illustrates an example of how these cost savings can be calculated, providing a detailed breakdown of the various components that contribute to the overall cost. This calculation can consider factors such as roaming charges, data usage costs, and potential economies of scale that might be achieved through network switching. By performing this comprehensive cost analysis, the mobile virtual network operator can make data-driven decisions about which subscribers to switch between networks, potentially realizing significant cost savings while maintaining or improving service quality for their customers.

FIG. 18 illustrates a comprehensive table 1800 that associates cell site identifiers with geographic location data and other relevant information, serving as a valuable component in both network switching and tower planning processes. This table provides a detailed database of cell site information that can be used for various analytical purposes. The table consists of several columns, each offering specific details about individual cell sites. The “Cell_identity” column 1802 contains unique identifiers for each cell site, which can be useful for distinguishing between different cell sites in the network and can be used to link cell site information across various datasets. For example, cell identity 1814 is “HASH1”, cell identity 1816 is “HASH2”, cell identity 1818 is “HASH3”, cell identity 1820 is “HASH4”, and cell identity 1822 is “HASH5”. The “Geo_point” column 1804 provides the precise geographic coordinates of each cell site, typically expressed as latitude and longitude. This information can enable accurate geospatial analysis, allowing network planners to visualize the distribution of cell sites and calculate distances between them. The “AOI” column 1806 indicates the Area of Interest to which each cell site belongs, representing specific geographic regions, market areas, or other meaningful divisions of the network's coverage area. Understanding which cell sites belong to which areas of interest can assist in regional analysis and planning, allowing for more targeted network optimization strategies.

The “City” column 1808, “State” column 1810, and “ZIP Code” column 1812 provide additional geographic context for each cell site. This information can be valuable for understanding the demographic and economic characteristics of the areas served by each cell site, which can inform both network switching decisions and tower planning strategies. For example, the table shows that cell identity 1814 is located in Elk Grove City, California, with ZIP code 95757. This level of detail allows planners to consider factors such as population density, economic activity, and local regulations when making decisions about network switches or tower placements. Similarly, cell identity 1816 is located in North Kansas City, Missouri, while cell identity 1818 is in Fairborn City, Ohio. This geographical diversity in the dataset demonstrates the wide-ranging coverage of the network and the potential need for location-specific strategies. The combination of precise geographic coordinates and broader location data enables multi-level analysis, from highly localized decision-making to broader regional strategies. This comprehensive location data can be particularly useful when correlating network performance and usage data with specific geographic areas, helping to identify patterns or trends that might inform network optimization decisions.

FIG. 19 presents a set 1900 of detailed tables that breaks down subscriber usage data by area of interest, providing insights for understanding how subscribers interact with the network across different geographic regions. This information can inform both network switching decisions and tower planning strategies. The table is organized into several examples, each representing a different subscriber or usage scenario. The “subscriber_hash” column contains anonymized identifiers for individual subscribers, allowing for user-level analysis while maintaining privacy. For example, subscriber hash 1902 is “HASH6” (such as 0eb08144ac2b176244dca7a9), subscriber hash 1914 is “HASH7”, subscriber hash 1926 is “HASH8”, and subscriber hash 1938 is “HASH9”. The “aoi” column 1904 indicates the Area of Interest where the usage occurred, corresponding to the AOI designations in FIG. 18. For instance, subscriber 1902 has usage in the STL area of interest. The “is_in_aoi” column 1906 is a boolean value indicating whether the usage occurred within the subscriber's primary or home area of interest. A corresponding is_in_aoi column 1918 is associated with subscriber hash 1914, another is_in_aoi column 1930 is associated with subscriber hash 1926, and another is_in_aoi column 1942 is associated with subscriber hash 1938. This information can be valuable for understanding roaming patterns and identifying opportunities for network switches or new tower placements.

The “data_usage_mb” column 1908 shows the amount of data consumed by the subscriber in megabytes, providing a quantitative measure of network usage. Corresponding data_usage_mb columns 1920, 1932, and 1944 are associated with subscriber hash 1914, subscriber hash 1926, and subscriber hash 1938, respectively. For example, subscriber 1926 used 1199.97071 MB in the JER area of interest. The “data_usage_fraction” column 1910 expresses this usage as a percentage of the subscriber's total data consumption, offering insight into the relative importance of different areas of interest for each subscriber. Corresponding data_usage_fraction columns 1922, 1934, and 1946 are associated with subscriber hash 1914, subscriber hash 1926, and subscriber hash 1938, respectively. The “bc_end” column 1912 represents the end date of the billing cycle for this usage data, which is 09/2023 for all examples shown. Corresponding bc_end columns 1924, 1936, and 1948 are associated with subscriber hash 1914, subscriber hash 1926, and subscriber hash 1938, respectively. This temporal information can be important for tracking usage patterns over time and ensuring that analysis is based on consistent time periods. By analyzing this data, network planners can identify areas of high usage that might benefit from additional capacity (either through network switches or new tower installations), as well as areas where usage is lower than expected, potentially indicating coverage or service quality issues that could be addressed.

FIG. 20 presents a detailed table 2000 of how cost savings are calculated when migrating subscribers from one network to another, which can be helpful for understanding the financial implications of network switching decisions. The table includes several columns that provide key data points for the savings calculation. The “subscriber_telephone_number_hash” column 2002 contains anonymized identifiers for individual subscribers, including an identifier 2020, an identifier 2022, an identifier 2024, an identifier 2026, and an identifier 2028. The “sub_max_usage_aoi” column 2004 indicates the area of interest where the subscriber has the highest usage. For instance, subscriber HASH10 has their maximum usage in the OMA area of interest. The “usage_aoi_covered_gb” 2006 and “total_usage_gb” 2008 columns show the amount of data used in gigabytes within the covered area of interest and in total, respectively. These usage figures can be used for calculating the potential cost savings of a network switch.

The “mno_roaming_cost_after_migration” column 2010 in FIG. 20 shows the expected roaming costs after switching the subscriber to a new network. The “mno_cost_after_migration” column 2012 represents the total cost to the mobile network operator after the switch. The “Total_cost_current” column 2014 shows the current cost before the switch, while the “Total_cost_after_migration” column 2016 shows the expected total cost after the switch. Finally, the “Savings” column 2018 represents the difference between the current cost and the post-migration cost, indicating the potential savings from the network switch. By way of illustrative example, subscriber HASH10 could show a savings of what could be $5.23, calculated as the difference between the current total cost of what could be $5.47 and the post-migration total cost of what could be $0.24.

The savings calculation formula for determining the potential cost reduction when transitioning a subscriber from a mobile virtual network operator to a mobile network operator can be expressed as follows: Savings=MVNO Cost-MNO Cost, where MNO Cost is defined as MNO Cost=(MNO covered rate*(1-In area roaming rate)*covered usage)+(roaming rate*((In area roaming rate*covered usage)+uncovered usage)). In this formula, MVNO Cost represents the total cost incurred by the mobile virtual network operator to serve the subscriber under the current arrangement. MNO Cost refers to the base cost charged by the mobile network operator for its services. The MNO covered rate is the rate applied to usage within the mobile network operator's network coverage area. The in-area roaming rate represents the proportion of usage that incurs roaming charges even within the mobile network operator's coverage area, which may occur due to network congestion or other factors. Covered usage is defined as the amount of data used within the mobile network operator's network coverage area. The roaming rate is the cost per unit of data for usage outside the mobile network operator's network or for in-area roaming. Uncovered usage represents the amount of data used outside the mobile network operator's network coverage area.

An example calculation using the data provided in the first row of the table in FIG. 20 can illustrate the application of this formula. For the subscriber withHASH10, the maximum usage is in the OMA (Omaha) area of interest. The usage_aoi_covered_gb value of 2.102944 GB represents the covered usage in the formula. The total_usage_gb is 2.128513 GB, from which the uncovered usage can be calculated as 0.025569 GB (2.128513-2.102944). By way of illustrative example, the Total_cost_current of what could be $5.47 corresponds to the MVNO Cost in the formula. The mno_roaming_cost_after_migration of what could be $0.03 can represent the roaming costs, while the mno_cost_after_migration of what could be $0.21 represents the MNO Cost for covered usage. To achieve the final savings of what could be $5.23, certain assumptions about the rates can be made for illustrative purposes. By way of illustrative example, assuming an MNO covered rate of $0.10 per GB and an in-area roaming rate of 1%, the roaming rate could be calculated as approximately $1.00 per GB. Applying these values to the formula could yield the following calculation: Savings=$5.47−[($0.21)+($1.00*((0.01*2.102944)+0.025569))]. This could result in a savings of $5.213431. It should be noted that in practice, the actual rates and in-area roaming percentages would be determined based on specific agreements between the mobile virtual network operator and mobile network operator, as well as network performance data. This example demonstrates how the savings calculation formula can be applied to real-world data to calculate potential cost reductions when switching a subscriber from a mobile virtual network operator to a mobile network operator service.

FIG. 21 illustrates an example scenario related to the method described in FIG. 1D, particularly focusing on the initial stage where a mobile virtual network operator detects that a network switch could improve telecommunication service for a client. The figure depicts a client 2104 utilizing an incompatible smartphone 2102 within a residential environment 2108. The incompatible smartphone 2102 displays a “No Service” icon 2106, indicative of the device's inability to establish a connection with the available network infrastructure. This scenario corresponds to the initial steps of the method outlined in FIG. 1D, where the mobile virtual network operator detects that an improvement in telecommunication service would result from performing a network switch. In the background, visible through a window, a cell tower 2110 is depicted. The cell tower 2110 represents the network infrastructure of a second mobile network operator, to which the client's home network could potentially be switched. A faint signal 2112 emanating from the cell tower 2110 symbolizes the potential for improved service that is currently unavailable to the client due to device incompatibility.

This configuration illustrates the condition described in the method of FIG. 1D, where the network switch is prohibited due to the client failing to satisfy a necessary condition-in this case, possessing a compatible device. The incompatible smartphone 2102 represents a client-controlled condition that prevents the successful execution of a beneficial network switch. The frustration exhibited by the client 2104 visually represents the suboptimal user experience resulting from the inability to connect to the potentially superior network infrastructure. This scenario underscores the need for the mobile virtual network operator to implement the subsequent steps of the method described in FIG. 1D, particularly the step of prompting the client to satisfy the necessary condition for performing the network switch. The residential setting 2108 provides context for the client's typical usage environment, emphasizing the importance of resolving connectivity issues to ensure satisfactory service in locations where clients commonly use their devices. This setting aligns with the method's goal of improving telecommunication service in a manner that directly impacts the client's day-to-day experience.

In other words, FIG. 21 helps to show how, in scenarios where the network switch is prohibited due to the client failing to satisfy a necessary condition, the condition can comprise the client using a mobile device model that is not supported by the second network infrastructure of the second mobile network operator. In such cases, prompting the client to satisfy the necessary condition can involve the mobile virtual network operator prompting the client to upgrade to a second mobile device model that is supported by the second network infrastructure of the second mobile network operator.

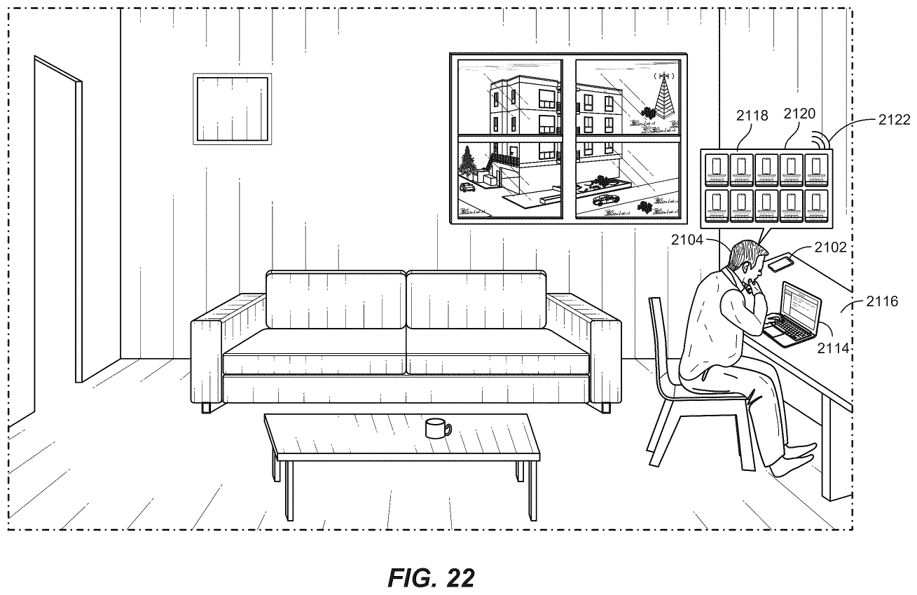

FIG. 22 illustrates a subsequent stage in the method described in FIG. 1D, specifically focusing on the mobile virtual network operator's process of notifying the client about the potential for service improvement and the client's decision-making process. The figure depicts the same client 2104 from FIG. 21, now in a different setting that emphasizes the communication and consideration aspects of the network switching process. The client 2104 is shown seated at a desk 2116, interacting with a laptop 2114 that displays an email from the mobile virtual network operator. This email communication represents a step in the method outlined in FIG. 1D, where the mobile virtual network operator prompts the client to take action to satisfy the necessary conditions for a beneficial network switch. The laptop 2114 featuring the mobile virtual network operator's email is an element of this figure. The content of the email, while not explicitly detailed in the image, is understood to explain the benefits of upgrading to a new phone for better service. This communication embodies the proactive approach described in the method of FIG. 1D, where the mobile virtual network operator engages directly with the client to address the identified service improvement opportunity. The email serves as a vehicle for educating the client about the potential benefits of a network switch and the steps required to enable this improvement, particularly the need for a compatible device. This direct communication method aligns with the goal of the described method to actively involve clients in the process of network optimization.

On the desk 2116, alongside the laptop 2114, the figure shows the client's current incompatible smartphone 2102, which is the same device depicted in FIG. 21. The presence of this device in the scene serves as a visual reminder of the existing limitation preventing optimal network service. The figure shows the subscriber considering a phone catalog 2118, which represents the options available to the client for upgrading to a compatible device. The inclusion of both the current incompatible device and the catalog of new options visually encapsulates the decision point faced by the client, illustrating the transition from the problem state to a potential solution. The thoughtful expression of the client 2104, with one hand on their chin, visually represents the decision-making process that the method in FIG. 1D aims to initiate. This contemplative pose indicates that the client is actively considering the information provided by the mobile virtual network operator and weighing the potential benefits of upgrading their device to enable the network switch. In view of the above, FIG. 22 helps illustrate how, when prompting the client to satisfy the necessary condition for the network switch, the mobile virtual network operator can provide an upgrade recommendation for a compatible mobile device model that operates with the second network infrastructure. This prompting can involve sending a notification to the client with instructions on how to meet the necessary condition for the network switch.

A thought bubble 2120 above the client's head further illustrates the client's mental process as they consider the potential benefits of upgrading their device. Within this thought bubble, an imagined new phone 2122 is depicted with a strong signal, visually representing the improved service that could result from the proposed upgrade and subsequent network switch. This visual element serves to reinforce the potential positive outcome of following the mobile virtual network operator's recommendation, aligning with the method's goal of improving telecommunication service for the client.

The details presented in FIG. 22 align with several aspects of the method described in FIG. 1D. The mobile virtual network operator's email corresponds to the step of prompting the client to satisfy the necessary condition for the network switch. The client's thoughtful consideration of this information, as depicted by their expression and the thought bubble, represents the intended response to this prompt. The presence of the phone catalog alongside the current incompatible device illustrates the specific action the client is being encouraged to take, which is upgrading to a compatible device.

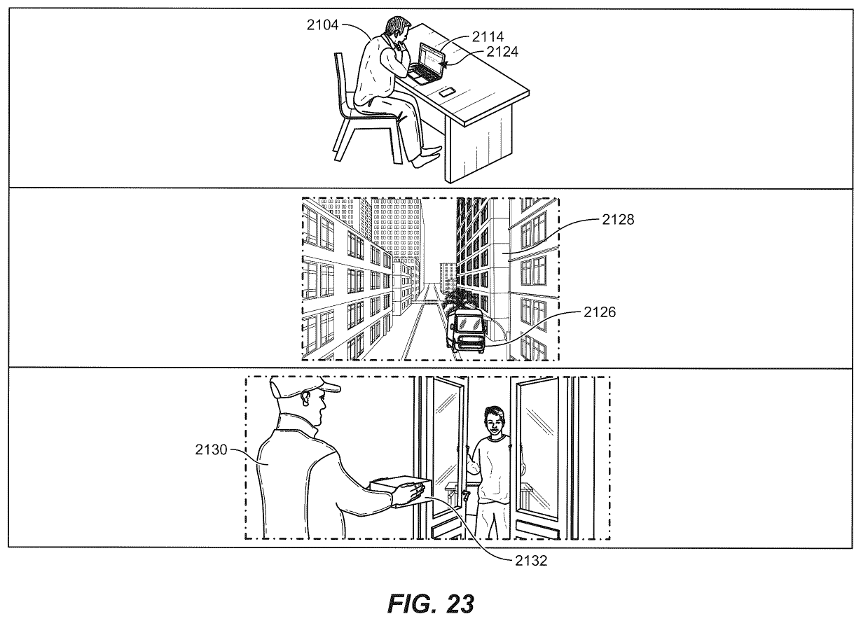

FIG. 23 illustrates a further progression in the method described in FIG. 1D, focusing on the client's decision to upgrade their device and the subsequent steps in the process. This figure is divided into three panels, each depicting a different stage of the upgrade process, collectively representing the client's journey from deciding to upgrade to receiving the new compatible device. The first panel shows the client 2104 engaging with their laptop 2114, now displaying a “Thank you for your order” message 2124. This visual representation indicates that the client has taken action based on the information provided by the mobile virtual network operator, as outlined in the method of FIG. 1D. The client's decision to order a new device demonstrates their compliance with the mobile virtual network operator's recommendation to satisfy the necessary condition for the network switch. This action represents a successful outcome of the prompting step described in the method, where the mobile virtual network operator encourages the client to take specific actions to enable service improvements.

The second panel of FIG. 23 depicts a delivery truck 2126 driving down a street 2128. This transitional image represents the process of fulfilling the client's order for a new compatible device. While not directly addressed in the method described in FIG. 1D, this step can be a natural consequence of the client's decision to upgrade their device. The inclusion of this panel in the figure underscores the practical aspects of implementing the method, highlighting the time and logistics involved in transitioning from an incompatible device to a compatible one. The delivery truck 2126 serves as a visual metaphor for the progress being made towards resolving the device compatibility issue identified earlier in the process.

The third panel of FIG. 23 shows the client 2104 at their front door, receiving a package 2132 from a delivery person 2130. This final panel represents the culmination of the upgrade process, where the client obtains the new compatible device. This step is significant in the context of the method described in FIG. 1D, as it marks the point at which the client has successfully satisfied the necessary condition for the network switch. The delivery of the new device signifies that the client is now equipped with hardware capable of connecting to the improved network infrastructure, as envisioned by the mobile virtual network operator. This panel illustrates the tangible outcome of the client's cooperation with the mobile virtual network operator's recommendation, setting the stage for the potential network switch and service improvement.

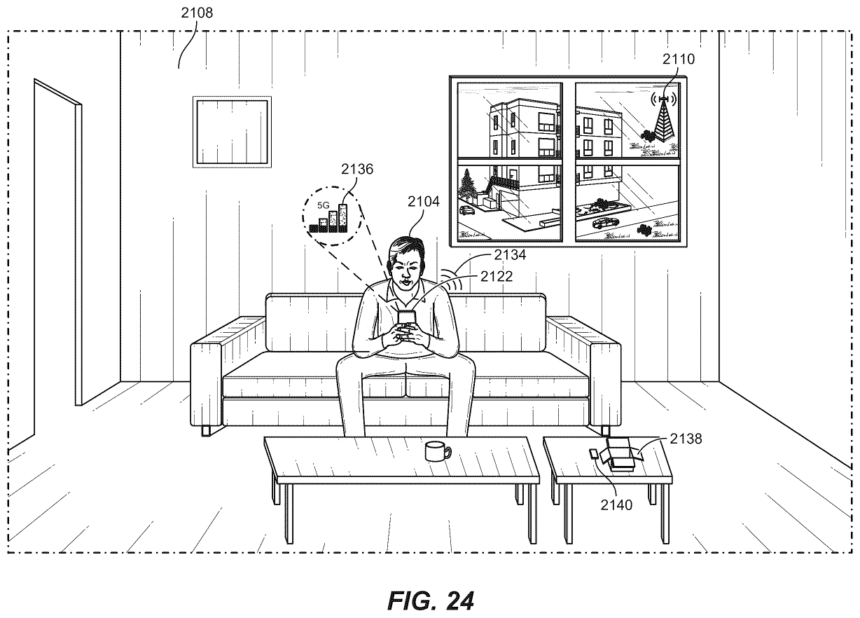

FIG. 24 illustrates the final stage in the method described in FIG. 1D, demonstrating the successful outcome of the network switch process. This figure revisits the living room setting introduced in FIG. 21, now showcasing the positive results of the client's device upgrade and the subsequent network switch. The client 2104 is depicted in the same living room 2108, but their demeanor and the overall atmosphere of the scene have transformed significantly. This visual representation serves to highlight the contrast between the initial problem state and the resolved situation, emphasizing the effectiveness of the method outlined in FIG. 1D. In this figure, the client 2104 is shown with a satisfied expression, a marked change from the frustrated appearance in FIG. 21. The client is now using their new compatible smartphone 2122, which was obtained through the upgrade process illustrated in FIG. 23. The phone's screen prominently displays a strong signal icon 2134 and a 5G symbol 2136, visual indicators of the improved network connectivity and service quality. These elements directly correspond to the goals of the method described in FIG. 1D, demonstrating that the network switch has resulted in tangible improvements to the client's telecommunication service. The strong signal icon 2134 and 5G symbol 2136 serve as clear visual representations of the benefits achieved through the implementation of the method, showing that the client now has access to a more robust and advanced network infrastructure.

The cell tower 2110, visible through the window, remains a consistent element from FIG. 21. However, in FIG. 24, the tower is now shown emitting a strong signal that reaches the client's new device. This visual change illustrates the successful connection between the client's upgraded device and the improved network infrastructure, a key objective of the network switch process. The transformation in the signal strength from FIG. 21 to FIG. 24 effectively communicates the resolution of the initial connectivity issues and the realization of the potential benefits that were anticipated earlier in the process. This aspect of the figure directly aligns with the method's goal of improving telecommunication service through strategic network switches. On a side table within the living room, an opened package 2138 and an instruction manual 2140 for the new phone are visible. These elements provide context for the recent completion of the upgrade process and serve as reminders of the steps taken to achieve the improved service. The presence of these items in the scene underscores the practical aspects of implementing the method described in FIG. 1D, highlighting that the process often involves tangible changes and actions on the part of the client. The instruction manual 2140, in particular, suggests the potential need for client education and support during the transition to a new device and network, an aspect that mobile virtual network operators may need to consider when implementing such upgrades.

Moreover, FIG. 24 underscores the potential long-term benefits of the network switch process for both the client and the mobile virtual network operator. The client's evident satisfaction suggests an improved user experience, which can lead to increased client retention and loyalty. For the mobile virtual network operator, the successful implementation of the network switch represents an optimization of network resources and potentially reduced operational costs. The figure thus illustrates how the method described in FIG. 1D can create a win-win situation, improving service quality for the client while potentially enhancing the efficiency and effectiveness of the mobile virtual network operator's service delivery.

Method 100D, as relating to FIGS. 21-24, focuses on situations where a mobile virtual network operator identifies a potential improvement in telecommunication service for a client through a network switch but finds the switch prohibited due to a client-controlled condition. While FIGS. 21-24 showcase device incompatibility as the prohibiting condition, a wide range of other conditions can fall under this category, each with its own potential resolution strategy.

One such condition could be the client's current service plan. In some scenarios, a client's existing plan might not be compatible with the target network infrastructure, either due to limitations on data allowances, roaming restrictions, or specific features not supported on the new network. In such cases, the mobile virtual network operator, upon detecting this incompatibility as the prohibiting condition, can prompt the client to change their service plan to one that aligns with the target network's capabilities. This prompt could be delivered through various channels, such as email, text message, or a notification within the mobile virtual network operator's mobile application. The mobile virtual network operator can provide the client with a selection of compatible service plans, highlighting the benefits of each plan and guiding them through the process of switching to a more suitable option.

Another condition that can prevent a beneficial network switch is the client's account status. For instance, a client with an outstanding balance, a suspended account, or an ongoing payment dispute might be ineligible for a network switch until these issues are resolved. In such cases, the mobile virtual network operator can, upon detecting these account-related issues as the prohibiting condition, prompt the client to take appropriate actions to restore their account to good standing. This prompt can include clear instructions on how to make a payment, reactivate their account, or resolve any outstanding disputes. The mobile virtual network operator might offer flexible payment options or grace periods to help clients resolve their account issues and become eligible for the network switch.

Client location settings can also present a prohibiting condition. Some mobile devices offer location-based services that allow clients to restrict network access based on their geographic location. For example, a client might have configured their device to connect only to specific Wi-Fi networks or to disable cellular data usage in certain areas. If these location settings conflict with the target network's coverage or capabilities, the mobile virtual network operator can prompt the client to adjust their location settings to enable the network switch. This prompt can include detailed instructions on how to modify the relevant settings on their device, ensuring that the client understands the impact of these settings on their network connectivity.

Additionally, client-configured network preferences can pose a challenge to network switching. Some devices allow clients to manually select their preferred network from a list of available options. If a client has manually chosen a different network than the one recommended by the mobile virtual network operator, this preference can prevent the automatic network switch from taking effect. The mobile virtual network operator can, in such cases, prompt the client to either enable automatic network selection or manually choose the target network from the list of available options. This prompt can explain the benefits of switching to the recommended network and guide the client through the process of making the necessary adjustments on their device.

Furthermore, certain regulatory requirements or legal restrictions can act as prohibiting conditions for network switches. For example, some regions may have regulations that restrict the transfer of phone numbers between specific mobile network operators or require clients to meet certain eligibility criteria before switching networks. In such cases, the mobile virtual network operator can inform the client about the relevant regulations or restrictions and guide them through the process of fulfilling the necessary requirements. This might involve providing the client with links to relevant regulatory documents, directing them to specific government websites, or assisting them with obtaining any required documentation.

In some scenarios, the prohibiting condition might be related to the client's device settings beyond network selection and location services. For instance, a client might have enabled a data saving mode on their device that limits background data usage or restricts access to certain network features. If these settings conflict with the target network's functionality, the mobile virtual network operator can prompt the client to adjust their device settings accordingly. This prompt can explain the impact of the data saving mode on their network experience and guide them through the steps to disable or modify the setting to enable the full functionality of the target network.

Another condition that can affect network switching is the presence of active services or applications that rely on specific network capabilities. For example, a client might be using a voice over IP (VoIP) application that requires a stable Internet connection or a cloud gaming service that demands high bandwidth and low latency. If the target network is unable to meet these requirements, the mobile virtual network operator can inform the client about potential service disruptions and prompt them to either pause or disable the conflicting applications during the network switch. This proactive approach can help minimize disruptions and ensure a smooth transition to the new network.

Method 100D, by enabling the mobile virtual network operator to proactively identify and address client-controlled conditions, enhances the effectiveness of network switching strategies. This approach ensures that clients who can benefit from a network switch are not unnecessarily excluded due to easily resolvable conditions. The prompt mechanism empowers clients to take control of their network experience, allowing them to make informed decisions about their service plan, device settings, and network preferences. By working collaboratively with clients, the mobile virtual network operator can maximize the success rate of network switches and deliver optimal telecommunication service.

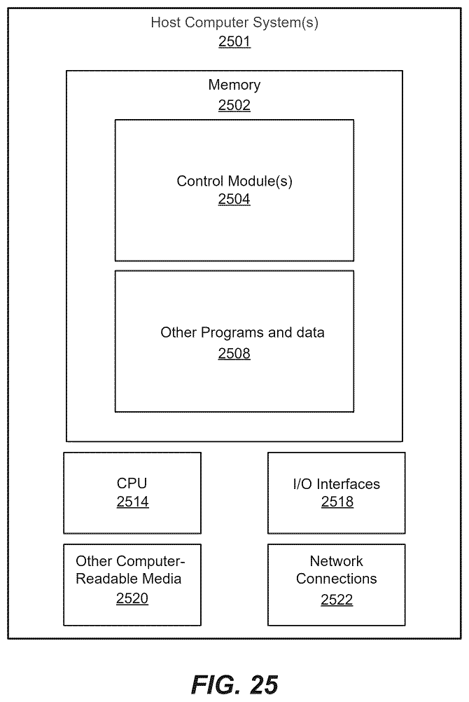

FIG. 25 shows a system diagram that describes an example implementation of a computing system(s) for implementing embodiments described herein. The functionality described herein can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 25 illustrates an example of underlying hardware on which such software and functionality may be hosted and/or implemented.

In particular, shown is example host computer system(s) 2501. For example, such computer system(s) 2501 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 2501 may include memory 2502, one or more central processing units (CPUs) 2514, I/O interfaces 2518, other computer-readable media 2520, and network connections 2522.

Memory 2502 may include one or more various types of non-volatile and/or volatile storage technologies. Examples of memory 2502 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 2502 may be utilized to store information, including computer-readable instructions that are utilized by CPU 2514 to perform actions, including those of embodiments described herein.

Memory 2502 may have stored thereon control module(s) 2504. The control module(s) 2504 may be configured to implement and/or perform some or all of the functions of the systems or components described herein. Memory 2502 may also store other programs and data 2508, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other functions, etc.

Network connections 2522 are configured to communicate with other computing devices to facilitate the functionality described herein. In various embodiments, the network connections 2522 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 2518 may include a video interface, other data input or output interfaces, or the like. Other computer-readable media 2520 may include other types of stationary or removable computer-readable media, such as removable flash drives, external hard drives, or the like.

1. A method comprising:
detecting, by a mobile virtual network operator, that an improvement in telecommunication service would result from performing a network switch that switches a home network of a client of the mobile virtual network operator from a first network infrastructure of a first mobile network operator that is serving clients for the mobile virtual network operator to a second network infrastructure of a second mobile network operator that is also serving clients for the mobile virtual network operator;
detecting, by the mobile virtual network operator, that the network switch is prohibited at least in part by detecting that the client has failed to satisfy a condition that is controlled at least in part by the client and that is necessary for performing the network switch successfully; and
prompting, by the mobile virtual network operator, in response to the mobile virtual network operator detecting that the network switch is prohibited at least in part by detecting that the client has failed to satisfy the condition that is controlled at least in part by the client and that is necessary for performing the network switch successfully, the client to satisfy the necessary condition in order for the mobile virtual network operator to perform the network switch that switches the client of the mobile virtual network operator from the first network infrastructure of the first mobile network operator that is serving clients for the mobile virtual network operator to the second network infrastructure of the second mobile network operator that is also serving clients for the mobile virtual network operator.

2. The method of claim 1, wherein the condition comprises the client using a mobile device model that is not supported by the second network infrastructure of the second mobile network operator that is also serving clients for the mobile virtual network operator.

3. The method of claim 2, wherein prompting, by the mobile virtual network operator, in response to the mobile virtual network operator detecting that the network switch is prohibited at least in part by detecting that the client has failed to satisfy the condition that is controlled at least in part by the client and that is necessary for performing the network switch successfully, the client to satisfy the necessary condition in order for the mobile virtual network operator to perform the network switch comprises prompting, by the mobile virtual network operator, the client to upgrade to a second mobile device model that is supported by the second network infrastructure of the second mobile network operator that is also serving clients for the mobile virtual network operator.

4. The method of claim 1, further comprising performing, by the mobile virtual network operator, the network switch.

5. The method of claim 4, further comprising receiving, by the mobile virtual network operator, an indication that the client has satisfied the condition that is controlled at least in part by the client and that is necessary for performing the network switch successfully.

6. The method of claim 5, wherein the mobile virtual network operator performs the network switch in response to receiving the indication that the client has satisfied the condition that is controlled at least in part by the client and that is necessary for performing the network switch successfully.

7. The method of claim 4, wherein the network switch is performed invisibly by switching an active profile on a subscriber identity mobile for the client from a first profile that is specific to the first network infrastructure of the first mobile network operator to a second profile that is specific to the second network infrastructure of the second mobile network operator.

8. The method of claim 7, wherein performing the network switch comprises switching an active profile on a subscriber identity module card of the client from a first profile corresponding to the first network infrastructure to a second profile corresponding to the second network infrastructure.

9. The method of claim 1, wherein prompting the client to satisfy the necessary condition comprises providing an upgrade recommendation for a compatible mobile device model that operates with the second network infrastructure.

10. The method of claim 1, wherein the prompting comprises sending a notification to the client with instructions on how to meet the necessary condition for the network switch.

11. A non-transitory computer-readable medium that has instructions stored thereon that, when executed by at least one physical computing processor, cause a computing device to perform operations comprising:
detecting, by a mobile virtual network operator, that an improvement in telecommunication service would result from performing a network switch that switches a home network of a client of the mobile virtual network operator from a first network infrastructure of a first mobile network operator that is serving clients for the mobile virtual network operator to a second network infrastructure of a second mobile network operator that is also serving clients for the mobile virtual network operator;
detecting, by the mobile virtual network operator, that the network switch is prohibited at least in part by detecting that the client has failed to satisfy a condition that is controlled at least in part by the client and that is necessary for performing the network switch successfully; and
prompting, by the mobile virtual network operator, in response to the mobile virtual network operator detecting that the network switch is prohibited at least in part by detecting that the client has failed to satisfy the condition that is controlled at least in part by the client and that is necessary for performing the network switch successfully, the client to satisfy the necessary condition in order for the mobile virtual network operator to perform the network switch that switches the client of the mobile virtual network operator from the first network infrastructure of the first mobile network operator that is serving clients for the mobile virtual network operator to the second network infrastructure of the second mobile network operator that is also serving clients for the mobile virtual network operator.

12. The non-transitory computer-readable medium of claim 11, wherein the condition comprises the client using a mobile device model that is not supported by the second network infrastructure of the second mobile network operator that is also serving clients for the mobile virtual network operator.

13. The non-transitory computer-readable medium of claim 12, wherein prompting, by the mobile virtual network operator, in response to the mobile virtual network operator detecting that the network switch is prohibited at least in part by detecting that the client has failed to satisfy the condition that is controlled at least in part by the client and that is necessary for performing the network switch successfully, the client to satisfy the necessary condition in order for the mobile virtual network operator to perform the network switch comprises prompting, by the mobile virtual network operator, the client to upgrade to another a second mobile device model that is supported by the second network infrastructure of the second mobile network operator that is also serving clients for the mobile virtual network operator.

14. The non-transitory computer-readable medium of claim 11, further comprising performing, by the mobile virtual network operator, the network switch.

15. The non-transitory computer-readable medium of claim 14, further comprising receiving, by the mobile virtual network operator, an indication that the client has satisfied the condition that is controlled at least in part by the client and that is necessary for performing the network switch successfully.

16. The non-transitory computer-readable medium of claim 15, wherein the mobile virtual network operator performs the network switch in response to receiving the indication that the client has satisfied the condition that is controlled at least in part by the client and that is necessary for performing the network switch successfully.

17. The non-transitory computer-readable medium of claim 14, wherein the network switch is performed invisibly by switching an active profile on a subscriber identity module for the client from a first profile that is specific to the first network infrastructure of the first mobile network operator to a second profile that is specific to the second network infrastructure of the second mobile network operator.

18. The non-transitory computer-readable medium of claim 11, wherein performing the network switch comprises switching an active profile on a subscriber identity module card of the client from a first profile corresponding to the first network infrastructure to a second profile corresponding to the second network infrastructure.

19. A system comprising:
at least one physical computing processor of a computing device; and
a non-transitory computer-readable medium that has instructions stored thereon that, when executed by the at least one physical computing processor, cause the computing device to perform operations comprising:
detecting, by a mobile virtual network operator, that an improvement in telecommunication service would result from performing a network switch that switches a home network of a client of the mobile virtual network operator from a first network infrastructure of a first mobile network operator that is serving clients for the mobile virtual network operator to a second network infrastructure of a second mobile network operator that is also serving clients for the mobile virtual network operator;
detecting, by the mobile virtual network operator, that the network switch is prohibited at least in part by detecting that the client has failed to satisfy a condition that is controlled at least in part by the client and that is necessary for performing the network switch successfully; and
prompting, by the mobile virtual network operator, in response to the mobile virtual network operator detecting that the network switch is prohibited at least in part by detecting that the client has failed to satisfy the condition that is controlled at least in part by the client and that is necessary for performing the network switch successfully, the client to satisfy the necessary condition in order for the mobile virtual network operator to perform the network switch that switches the client of the mobile virtual network operator from the first network infrastructure of the first mobile network operator that is serving clients for the mobile virtual network operator to the second network infrastructure of the second mobile network operator that is also serving clients for the mobile virtual network operator.

20. The system of claim 19, wherein the condition comprises the client using a mobile device model that is not supported by the second network infrastructure of the second mobile network operator that is also serving clients for the mobile virtual network operator.
